(19) United States
(12) Patent Application Publication
(10) Pub. No.: US 2016/0019598 A1
(43) Pub. Date: Jan. 21, 2016

(54) TARGETED ADVERTISING AND ATTRIBUTION ACROSS MULTIPLE SCREENS BASED ON PLAYING GAMES ON A GAME CONSOLE THROUGH A TELEVISION

(71) Applicant: David Harrison, San Francisco, CA (US)

(72) Inventor: David Harrison, San Francisco, CA (US)

(21) Appl. No.: 14/744,045

(22) Filed: Jun. 19, 2015

Related U.S. Application Data
(60) Provisional application No. 62/026,017, filed on Jul. 17, 2014.

(51) Int. Cl. G06Q 30/02

(52) U.S. Cl. CPC G06Q 30/0275; G06Q 30/0277

(57) ABSTRACT

Disclosed are a method and/or a system of targeted advertising and attribution across multiple screens based on playing games on a game console through a television. A method of a game identification server includes comparing a game identifying data received from the television through an Internet network with a game identification database to determine a game identifier. The game identifying data is generated using a game identification algorithm of the television. The game identifying data is communicated to the game identification server. The game identifier is associated with a public IP address of the television. At least one client ID associated with the public IP address using a device map table is determined. The client device associated with a particular client ID associated with the game identifier provides an advertising spot to an advertising exchange that provides an opportunity to a real time bidder to place a bid for advertisement.

### CLAIM OF PRIORITY

This non-provisional patent application is a conversion application of and claims priority to the U.S. Provisional patent application No. 62/026,017 titled ‘AUTOMATIC GAMING ADVERTISEMENT IDENTIFICATION, TIME STAMPING, AND CATALOGING BASED ON VIEWING HISTORY OF A USER OPERATING A MOBILE DEVICE COMMUNICATIVELY COUPLED WITH A NETWORKED TELEVISION, AND DELIVERY OF A TARGETED ADVERTISEMENT TO THE MOBILE DEVICE BASED ON THE IDENTIFICATION AND CATALOGING WITHIN A THRESHOLD AMOUNT OF TIME FROM A TIME STAMP OF AN IDENTIFIED ADVERTISEMENT DISPLAYED ON THE NETWORKED TELEVISION’ filed on Jul. 17, 2014.

### FIELD OF TECHNOLOGY

This disclosure relates generally to networking technology, and, more particularly, to a method and/or a system of targeted advertising and attribution across multiple screens based on playing games on a game console through a television.

### BACKGROUND

Video games have become a popular entertainment option for many consumers. As a result, video games have increasingly replaced watching television as a preferred relaxation and entertainment method for a large percentage of world audiences. Perhaps, the interactivity and dynamic stimulation offered by video game interaction might satisfy a more compelling human need than statically watching television. Furthermore, consumers that play video games often spend more time on a game they like, than they typically would in watching a television show, going to a movie, and/or playing physical sports. As a result, the creation of video games has become a lucrative business.

Competition among video game companies has created a new age of expansive production and advertising budgets for new games, often exceeding $30 million dollars or more. Despite this, targeting of the potential customer audiences for a particular video game has been a difficult challenge for many game developers. Therefore, game developers may spend advertising budgets inefficiently through online and offline brand advertising prior to and shortly after a game release without a clear idea if a game is going to ultimately be successful. The largest game studios can have up to 100 people working for a single project. Without clear estimation of a game's potential demand, many game developers may go bankrupt. In fact, the majority of commercial games may not produce a profit. As a result, many developers close down because they cannot target potential customers adequately in advance of and shortly after releasing a game.

### SUMMARY

Disclosed are a method and/or a system of targeted advertising and attribution across multiple screens based on playing games on a game console through a television.

In one aspect, a method of a game identification server includes comparing a game identifying data received from a television through an Internet network with a game identification database to determine a game identifier associated with the game identifying data. The game identifying data is generated using a game identification algorithm of the television based on a data provided to the television while a game is being played through a game console communicatively coupled with the television. The game identifying data is communicated to the game identification server from the television through the Internet network.

The method associates the game identifier with the television associated with a public IP address and/or an IP address range. Further, at least one client ID associated with the public IP address and/or the IP address range is determined using a device map table. In addition, at least one client ID is associated with the game identifier. Furthermore, the method determines a particular client ID received from a client device is the at least one client ID associated with the game identifier. The client device associated with the particular client ID associated with the game identifier provides an advertising spot to an advertising exchange. The advertising exchange provides an opportunity to a real time bidder to place a bid for an advertisement to be placed in the advertising spot.

A location identifier of an advertisement of another game to the game associated with the game identifier is provided to the client device providing the advertising spot upon successfully winning the bid from the advertising exchange. The advertisement is placed on an available advertising spot on the client device when the client device accesses an ad server having the advertisement through the location identifier.

The method of the game identification server may include determining that the advertisement is displayed on the client device based on a request embedded in the advertisement on the client device that communicates a public IP address, an IP address range, a client id, and/or an ad id, to an attribution analyzer. The method may determine that the public IP address and/or the client ID is associated with the client device. Further, the method may place an association of the advertisement with the client device in an attribution table.

The method may compare an another game identifying data received from the television through the Internet network with the game identification database to determine that another game identifier associated with the another game identifying data is that of an another game. Additionally, the method may determine that the advertisement likely caused a play and/or a purchase of the another game when it is determined that the client device displayed the advertisement based on the association of the advertisement with the client device in the attribution table and/or the another game identifier associated with the another game identifying data is that of the another game.

The public IP address may be automatically visible to the game identification server. The data may be an audio, a video, and/or a metadata generated by at least one of the game and the game console. The location identifier may be a Uniform Resource Locator (URL) code. The request to place a cookie on the client device may be performed such that the cookie to include the client ID of the client device and may communicate the client ID to the attribution analyzer, the advertising exchange, and/or the real time bidder. The request may be a pixel having an embedded image Uniform Resource Locator (URL) that refers to the attribution analyzer.

A user identifying data may be generated using a user identification algorithm of the television based on the data provided to the television while the game is being played through the game console communicatively coupled with the television. The data may be a video data, an audio data, and/or a metadata. A behavioral data may be generated using a behavior identification algorithm of the television for each user identified using the user identification algorithm based on the data provided to the television while the game is being played through the game console communicatively coupled with the television. Examples of the behavioral data may include a length of game play, a stopping location of the game, a level of the game, how often the game is played, and/or how long the game is played.

A game identifying data may be a name, a game title, an audio fingerprint, a video fingerprint, a game logo detection, an optical character recognition of the game title, a splash screen, an automatic content recognition data, and/or a metadata provided from the game console to the television. The game identifier may be a game name, a stock keeping unit, a game genre, an age group, a game version, and/or a game language. The ad server may store creative artwork associated with potential advertisements.

The client ID may be a DoubleClick® ID, a Google® GID, an Apple® IDFA, and/or an AppNexus® ID. The client ID may maintain a static identifier across different physical locations of the client device. The client device may be a mobile phone, a tablet, a desktop computer, an Internet enabled appliance, a wearable computer, an Internet enabled watch, an Internet enabled glasses, a projected computing environment and/or the television itself. The another game may be a newly released game, a similar game, a complementary game, and/or a related game.

The advertising spot may be a display advertisement spot, a text advertisement spot, a video advertisement spot, an audio advertisement spot, a banner advertisement spot, and/or a textual advertisement spot. The advertisement spot may include metadata about a name of an application and/or website in which the advertisement appears. a location of the advertisement spot, a size of the advertisement spot, and/or a type of the advertisement spot.

The method may further determine that the game is accessed through a game console. The method may analyze a session of play by a user of the game. In addition, the method may determine a timing and/or a location of a game event rendered during the session of play by the user of the game in the game accessed through the game console. The game event may be an appearance of a game object, reaching a level, an amount of time played, and/or a number of times played. Furthermore, the method may apply an automatic event recognition algorithm to the game event to determine that the game event is associated with a product and/or a service for sale.

The method may associate a time stamp with the session of play and/or the timing and/or the location of the game event. The method may determine the client device is associated with the user that accesses the game through the game console. An advertisement formatted for a display area of the client device that is associated with the game event based on a contextual match between the game event and the advertisement may be selected. The advertisement may be delivered to the client device within a predetermined time threshold of the time stamp associated with the session of play and/or the timing and/or the location of the game event.

The advertisement may be an alphanumeric advertisement, a textual advertisement a display advertisement, and/or an audio-visual advertisement. The method may further determine that the user has interacted with the advertisement when the user selects a hyperlink in the advertisement. The game event on the game console may be periodically displayed based on a determination that the user has interacted with the advertisement by selecting the hyperlink in the advertisement.

The method may further automatically infer a current association and/or a previous association of the client device with the television and/or the game console. In addition, a first advertisement displayed on the television by the game console and/or broadcast directly to the television may be automatically identified. The time stamp may be automatically associated with the first advertisement. Additionally, the method may automatically target a second advertisement to the client device based on the first advertisement and within the predetermined time threshold of the time stamp.

The method may determine that the user has interacted with the second advertisement when the user selects the hyperlink in the second advertisement. The first advertisement may be periodically displayed on the game console based on the determination that the user has interacted with the second advertisement by selecting the hyperlink in the second advertisement. The first advertisement may be automatically catalogued. The first advertisement may be a virtual object.

The automatic identifying may be through a tag associated with the first advertisement. A second advertisement may be automatically targeted to the client device during an inferred interaction of the user with the client device and/or an inferred cessation of interaction of the user with the game console. The inferring and/or the automatically targeting may be through a web browser and/or an application of the client device. The second advertisement may be interactive.

The current association and/or the previous association of the client device with the television and/or the game console may be inferred based on an IP address range, the public IP address, a base station MAC address, a base station BSSID, a base station SSID, a Bluetooth® MAC address, a geolocation, a WiFi direct MAC address of the game console, a WiFi direct BSSID of the game console, a short code, a username, and/or a quick response (QR) code that is shared by and/or visible to both the client device and the television and/or the game console.

The current association and/or the previous association of the client device with the television and/or the game console may be inferred based on a mutually visible identifying signal from the game console and/or a device external to the game console, independent of whether the game console and/or the client device can connect to a third device other than to receive the identifying signal. The current association and/or the previous association of the client device with the television and/or the game console may be inferred based on whether redirecting a browser of the client device and/or an application of the client device to a private IP address of the game console establishes a communication between the client device and the television and/or the game console.

The current association and/or the previous association of the client device with the television and/or the game console may be inferred based on whether instructing an application of the client device to perform a multicast and/or a broadcast based discovery establishes a communication between the client device and the television and/or the game console. The automatic identifying may be through an automatic content recognition (ACR) of the television and/or the game console.

In another aspect, a method of a game identification server includes comparing a game identifying data received from a television through an Internet network with a game identification database to determine a game identifier associated with the game identifying data. The game identifying data is generated using a game identification algorithm of the television based on a data provided to the television while a game is being played through a game console communicatively coupled with the television. The game identifying data is communicated to the game identification server from the television through the Internet network.

The game identifier is associated with a public IP address, an IP address range, and/or a unique identifier of the television. The method determines that an advertisement is displayed on a client device based on a request embedded in the advertisement on the client device that communicates the public IP address, the IP address range, the unique identifier, a client id, and/or an ad id, to an attribution analyzer. At least one client ID associated with the public IP address, the IP address range, and/or the unique identifier using a device map table is determined. At least one client ID is associated with the game identifier. The method determines a particular client ID received from the client device is the at least one client ID associated with the game identifier.

The client device associated with the particular client ID associated with the game identifier provides an advertising spot to an advertising exchange. The advertising exchange provides an opportunity to a real time bidder to place a bid for the advertisement to be placed in the advertising spot. A location identifier of an advertisement of another game to the game associated with the game identifier is provided to the client device providing the advertising spot upon successfully winning the bid from the advertising exchange. The advertisement is placed on an available advertising spot on the client device when the client device accesses an ad server having the advertisement through the location identifier.

In yet another aspect, a system includes a game identification server to compare a game identifying data received from a television through an Internet network with a game identification database to determine a game identifier associated with the game identifying data. The game identifying data is generated using a game identification algorithm of the television based on a data provided to the television while a game is being played through a game console communicatively coupled with the television. The game identifying data is communicated to the game identification server from the television through the Internet network.

The game identifier is associated with a public IP address and/or an IP address range of the television. At least one client ID associated with the public IP address and/or the IP address range is determined using a device map table. At least one client ID is associated with the game identifier. The system includes an Internet. The system further includes a client device to provide a particular client id. The system determines the particular client ID received from the client device is the at least one client ID associated with the game identifier.

The client device associated with the particular client ID associated with the game identifier provides an advertising spot to an advertising exchange. The advertising exchange provides an opportunity to a real time bidder to place a bid for an advertisement to be placed in the advertising spot. A location identifier of an advertisement of another game to the game associated with the game identifier is provided to the client device providing the advertising spot upon successfully winning the bid from the advertising exchange. The advertisement is placed on an available advertising spot on the client device when the client device accesses an ad server having the advertisement through the location identifier.

The method, apparatus, and system disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the Figures of the accompanying drawings, in which like references indicate similar elements and in which:

FIG. 1A is a network view of a game identification server illustrating the comparing of a game identifying data received from a television through an Internet network with a game identification database to determine a game identifier associated with the game identifying data while a game is being played through a game console communicatively coupled with the television, according to one embodiment.

FIG. 1B is an interaction view of a real time bidder being presented with an opportunity to place a bid for an advertisement to a client device associated with a particular client id associated with the game identifier of the game identification computer server of FIG. 1A, according to one embodiment.

FIG. 2 is a purchase causing view illustrating effecting a purchase of an another game after determining that the client device displayed the advertisement based on the association of the advertisement with the client device in an attribution table of game identification server FIG. 1A, according to one embodiment.

FIG. 3 is an attribution view of the client device associated with the game console of the game identification server of FIG. 1A, according to one embodiment.

FIG. 4 is a user identification view illustrating the generation of user identification data using the user identification algorithm of the television of game identification server of FIG. 1A, according to one embodiment.

FIG. 5 is an exploded view of the game identification server of FIG. 1A, according to one embodiment.

FIG. 6 is an exploded view of an advertising spot on the television of the game identification server of FIG. 1A, according to one embodiment.

FIG. 7 is a rendering view illustrating the selection of an advertisement formatted for a display area of a client device that is associated with a game event based on a contextual match between the game event and the advertisement of the game identification server FIG. 1A, according to one embodiment.

FIG. 8 is a block diagram illustrating the automatic cataloguing of first advertisement of the game identification server of FIG. 1A, according to one embodiment.

FIG. 9A is a critical path view illustrating a flow based on time in which critical operations of the game identification server of FIG. 1A will occur, according to one embodiment.

FIG. 9B is a continuation of the critical path view of FIG. 9A illustrating the critical operations of the game identification server of FIG. 1A, according to one embodiment.

FIG. 10 is a process flow illustrating the generation of a game identifying data using a game identification algorithm of a television based on a data provided to the television while a game is being played through a game console communicatively coupled with the television of FIG. 1A, according to one embodiment.

FIG. 11 is a schematic diagram of exemplary data processing devices that can be used to implement the methods and systems disclosed herein, according to one embodiment.

Other features of the present embodiments will be apparent from the accompanying drawings and from the detailed description that follows.

### DETAILED DESCRIPTION

Disclosed are a method and/or a system of targeted advertising and attribution across multiple screens based on playing games on a game console through a television.

In one embodiment, a method of a game identification server 100 includes comparing (e.g., using the compare function 121 of the game identification server 100) a game identifying data 102 received from a television 104 through an Internet network 106 with a game identification database 108 to determine a game identifier 110 associated with the game identifying data 102. The game identifying data 102 is generated using a game identification algorithm 112 of the television 104 based on a data 114 provided to the television 104 while a game 116 is being played through a game console 118 communicatively coupled with the television 104. The game identifying data 102 is communicated to the game identification server 100 from the television 104 through the Internet network 106.

The method associates the game identifier 110 with the television 104 associated with a public IP address 120 and/or an IP address range. Further, at least one client ID 124 associated with the public IP address 120 and/or the IP address range is determined using a device map table 126. In addition, at least one client ID 124 is associated with the game identifier 110. Furthermore, the method determines a particular client ID 128 received from a client device 130 is at least one client ID 124 associated with the game identifier 110. The client device 130 associated with the particular client ID 128 associated with the game identifier 110 provides an advertising spot 132 to an advertising exchange 134. The advertising exchange 134 provides an opportunity 137 to a real time bidder 136 to place a bid 138 for an advertisement 140 to be placed in the advertising spot 132.

A location identifier 142 of an advertisement of another game 144 to the game 116 associated with the game identifier 110 is provided to the client device 130 providing the advertising spot 132 upon successfully winning the bid 138 from the advertising exchange 134. The advertisement 140 is placed on an available advertising spot 146 on the client device 130 when the client device 130 accesses an ad server 122 having the advertisement 140 through the location identifier 142.

The method of the game identification server 100 may include determining that the advertisement 140 is displayed on the client device 130 based on a request 202 embedded in the advertisement 140 on the client device 130 that communicates a public IP address 120, an IP address range, a client ID 124, and/or an ad id 312, to an attribution analyzer 204. The method may determine that the public IP address 120 and/or the client ID 124 is associated with the client device 130. Further, the method may place an association 206 of the advertisement 140 with the client device 130 in an attribution table 208. In another embodiment, there may be an additional table that may store game plays by mapping the unique identifier 123 of the television 104 to the game identifier110. In a further embodiment, there may be a further table that may map another game identifier to another game advertisement identifier. The attribution table 208 may compare the times of exposures to advertisements (e.g., the advertisement 140) to the times of game plays to determine whether to attribute the game play to the advertisement exposure.

The method may compare an another game identifying data 210 received from the television 104 through the Internet network 106 with the game identification database 108 to determine that another game identifier associated with the another game identifying data 210 is that of an another game 212. Additionally, the method may determine that the advertisement 140 likely caused a play and/or a purchase 214 of the another game 212 when it is determined that the client device 130 displayed the advertisement 140 based on the association 206 of the advertisement 140 with the client device 130 in the attribution table 208 and/or the another game identifier associated with the another game identifying data 210 is that of the another game 212. It will be appreciated that in one embodiment, the client device 130 may be associated with the television 104 on which the another game 212 was played through an algorithm. The algorithm may 1) evaluate the another game 212 on the television 104 with the unique identifier 123 2) generate the another game identifying data 210, 3) identify the another game 212 by its another game identifier, 4) map from the unique identifier 123 of the television 104 associated client IDs (e.g., the client ID 124), 5) map the another game identifier to its associated another game advertisement identifier(s), and then 6) match client IDs (e.g., the client ID 124) of those exposed to another game advertisement (e.g., the advertisement of another game 144) to associated televisions (e.g., the television 104) on which the another game 212 was detected.

The public IP address 120 may be automatically visible to the game identification server 100. The data 114 may be an audio, a video, and/or a metadata generated by the game 116 and/or the game console 118. The location identifier 142 may be a Uniform Resource Locator (URL) code 304. The request 202 to place a cookie 306 on the client device 130 may be performed such that the cookie 306 to include the client ID 124 of the client device 130 and may communicate the client ID 124 to the attribution analyzer 204, the advertising exchange, 134, and/or the real time bidder136. The request 202 may be a pixel 308 having an embedded image Uniform Resource Locator (URL) 304 that refers to the attribution analyzer 204.

A user identifying data 406 may be generated using a user identification algorithm 402 of the television 104 based on the data 114 provided to the television 104 while the game 116 is being played through the game console 118 communicatively coupled with the television 104. The data 114 may be a video data, an audio data, and/or a metadata. A behavioral data 408 may be generated using a behavior identification algorithm 404 of the television 104 for each user 109 identified using the user identification algorithm 402 based on the data 114 provided to the television 104 while the game 116 is being played through the game console 118 communicatively coupled with the television 104. Examples of the behavioral data 408 may include a length of game play, a stopping location of the game, a level of the game, how often the game is played, and/or how long the game is played.

A game identifying data 102 may be a name 504, a game title 506, an audio fingerprint 508, a video fingerprint 510, a game logo detection 512, an optical character recognition of the game title 514, a splash screen 516, an automatic content recognition data 518, and/or a metadata 520 provided from the game console 118 to the television 104. The game identifier 110 may be a game name 522, a stock keeping unit 524, a game genre 526, an age group 528, a game version 530, and/or a game language 532. The ad server 122 may store creative artwork associated with potential advertisements.

The client ID 124 may be any one of a DoubleClick® ID, a Google® GID, an Apple® IDFA, or an AppNexus® ID. The client ID 124 may maintain a static identifier across different physical locations of the client device 130. The client device 130 may be a mobile phone, a tablet, a desktop computer, an Internet enabled appliance, a wearable computer, an Internet enabled watch, an Internet enabled glasses, a projected computing environment and/or the television 104 itself. The another game 212 may be a newly released game, a similar game, a complementary game, and/or a related game.

The advertising spot 132 may be a display advertisement spot 602, a text advertisement spot 604, a video advertisement spot 606, an audio advertisement spot 608, a banner advertisement spot 610, and/or a textual advertisement spot 612. The advertisement spot 132 may include metadata about a name of an application and/or a website in which the advertisement 140 appears, a location of the advertisement spot, a size of the advertisement spot, and/or a type of the advertisement spot.

The method may further determine that the game is accessed through a game console 118. The method may analyze a session of play 704 by a user 109 of the game 116. In addition, the method may determine a timing 708 and/or a location 710 of a game event 716 rendered during the session of play 704 by the user 109 of the game 116 in the game accessed through the game console 118. The game event 716 may be an appearance of a game object, reaching a level, an amount of time played, and/or a number of times played. Furthermore, the method may apply an automatic event recognition algorithm 714 to the game event 716 to determine that the game event 716 is associated with a product 718 and/or a service for sale 720.

The method may associate a time stamp 722 with the session of play 704 and/or the timing 708 and/or the location 710 of the gaming event 716. The method may determine the client device 130 is associated with the user 109 that accesses the game 116 through the game console 118. An advertisement 140 formatted for a display area 726 of the client device 130 that is associated with the game event 716 based on a contextual match 706 between the game event 716 and the advertisement 140 may be selected. The advertisement 140 may be delivered to the client device 130 within a predetermined time threshold 728 of the time stamp 722 associated with the session of play 704 and/or the timing 708 and/or the location of the game event 716.

The advertisement 140 may be an alphanumeric advertisement, a textual advertisement a display advertisement, and/or an audio-visual advertisement. The method may further determine that the user 109 has interacted with the advertisement 140 when the user 109 selects a hyperlink 730 in the advertisement 140. The game event 716 may be periodically displayed on the game console 118 based on a determination that the user 109 has interacted with the advertisement 140 by selecting the hyperlink 730 in the advertisement 140.

The method may further automatically infer a current association and/or a previous association of the client device 130 with the television 104 and/or the game console 118. In addition, a first advertisement 802 displayed on the television 104 by the game console 118 and/or broadcast directly to the television 104 may be automatically identified. may be automatically identified. The time stamp 722 may be automatically associated with the first advertisement 802. Additionally, the method may automatically target a second advertisement 804 to the client device 130 based on the first advertisement 802 and/or within the predetermined time threshold 728 of the time stamp 722.

The method may determine that the user 109 has interacted with the second advertisement 804 when the user 109 selects the hyperlink 730 in the second advertisement 804. The first advertisement 802 may be periodically displayed on the game console 118 based on the determination that the user 109 has interacted with the second advertisement 804 by selecting the hyperlink 730 in the second advertisement 804. The first advertisement 802 may be automatically catalogued. The first advertisement 802 may be a virtual object.

The automatic identifying may be through a tag 806 associated with the first advertisement 802. The second advertisement 804 may be automatically targeted to the client device 130 during an inferred interaction of the user 109 with the client device 130 and/or an inferred cessation of interaction of the user 109 with the game console 118 (e.g., when the television 104 starts rendering live television broadcasts.) The inferring and/or the automatically targeting may be through a web browser and/or an application of the client device 130. The second advertisement 804 may be interactive.

The current association and/or the previous association of the client device 130 with the television 104 and/or the game console 118 may be inferred based on the IP address range, the public IP address 120, a base station MAC address, a base station BSSID, a base station SSID, a Bluetooth® MAC address, a geolocation, a WiFi direct MAC address of the game console, a WiFi direct BSSID of the game console, a short code, a user name, and/or a quick response (QR) code that is shared by and/or visible to both the client device 130 and the television 104 and/or the game console 118.

The current association and/or the previous association of the client device 130 with the television 104 and/or the game console 118 may be inferred based on a mutually visible identifying signal from the game console 118 and/or a device external to the game console 118, independent of whether the game console 118 and/or the client device 130 can connect to a third device other than to receive the identifying signal. The current association and/or the previous association of the client device 130 with the television 104 and/or the game console 118 may be inferred based on whether redirecting a browser of the client device 130 and/or an application of the client device 130 to a private IP address of the game console 118 establishes a communication between the client device 130 and the television 104 and/or the game console 118.

The current association and/or the previous association of the client device 130 with the television 104 and/or the game console 118 may be inferred based on whether instructing an application of the client device 130 to perform a multicast and/or a broadcast based discovery establishes a communication between the client device 130 and the television 104 and/or the game console 118. The automatically identifying may be through an automatic content recognition (ACR) (e.g., using the automatic content recognition (ACR) algorithm 302) of the television 104 and/or the game console 118.

In another embodiment, a method of a game identification server 100 includes comparing (e.g., using the compare function 121 of the game identification server 100) a game identifying data 102 received from a television 104 through an Internet network 106 with a game identification database 108 to determine a game identifier 110 associated with the game identifying data 102. The game identifying data 102 is generated using a game identification algorithm 112 of the television 104 based on a data provided to the television 104 while a game 116 is being played through a game console 118 communicatively coupled with the television 104. The game identifying data 102 is communicated to the game identification server 100 from the television 104 through the Internet network 106.

The game identifier 110 is associated with a public IP address 120, an IP address range, and/or a unique identifier 123 of the television 104. The method determines that an advertisement 140 is displayed on a client device 130 based on a request 202 embedded in the advertisement 140 on the client device 130 that communicates the public IP address 120, the IP address range, the unique identifier 123, a client ID 124, and/or an ad id 312, to an attribution analyzer 204. At least one client ID 124 associated with the public IP address 120, the IP address range, and/or the unique identifier 123 is determined using a device map table 126. At least one client ID 124 is associated with the game identifier 110. The method determines a particular client ID 128 received from the client device 130 is the at least one client ID 124 associated with the game identifier 110.

The client device 130 associated with the particular client ID 128 associated with the game identifier 110 provides an advertising spot 132 to an advertising exchange 134. The advertising exchange 134 provides an opportunity 137 to a real time bidder 136 to place a bid 138 for the advertisement 140 to be placed in the advertising spot 132. A location identifier 142 of an advertisement of another game 144 to the game 116 associated with the game identifier 110 is provided to the client device 130 providing the advertising spot 132 upon successfully winning the bid 138 from the advertising exchange 134. The advertisement 140 is placed on an available advertising spot 146 on the client device 130 when the client device 130 accesses an ad server 122 having the advertisement 140 through the location identifier 142.

In yet another embodiment, a system includes a game identification server 100 to compare (e.g., using the compare function 121 of the game identification server 100) a game identifying data 102 received from a television 104 through an Internet network 106 with a game identification database 108 to determine a game identifier 110 associated with the game identifying data 102. The game identifying data 102 is generated using a game identification algorithm 112 of the television 104 based on a data 114 provided to the television 104 while a game 116 is being played through a game console 118 communicatively coupled with the television 104. The game identifying data 102 is communicated to the game identification server 100 from the television 104 through the Internet network 106.

The game identifier 110 is associated with a public IP address 120 and/or an IP address range of the television 104. At least one client ID 124 associated with the public IP address 120 and/or the IP address range is determined using a device map table 126. At least one client ID 124 is associated with the game identifier 110. The system includes an Internet. The system further includes a client device 130 to provide a particular client ID 128. The system determines the particular client ID 128 received from the client device 130 is the at least one client ID 124 associated with the game identifier 110.

The client device 130 associated with the particular client ID 128 associated with the game identifier 110 provides an advertising spot 132 to an advertising exchange 134. The advertising exchange 134 provides an opportunity 137 to a real time bidder 136 to place a bid 138 for an advertisement 140 to be placed in the advertising spot 132. A location identifier 142 of an advertisement of another game 144 to the game 116 associated with the game identifier 110 is provided to the client device 130 providing the advertising spot 132 upon successfully winning the bid 138 from the advertising exchange 134. The advertisement 140 is placed on an available advertising spot 146 on the client device 130 when the client device 130 accesses an ad server 122 having the advertisement 140 through the location identifier 142.

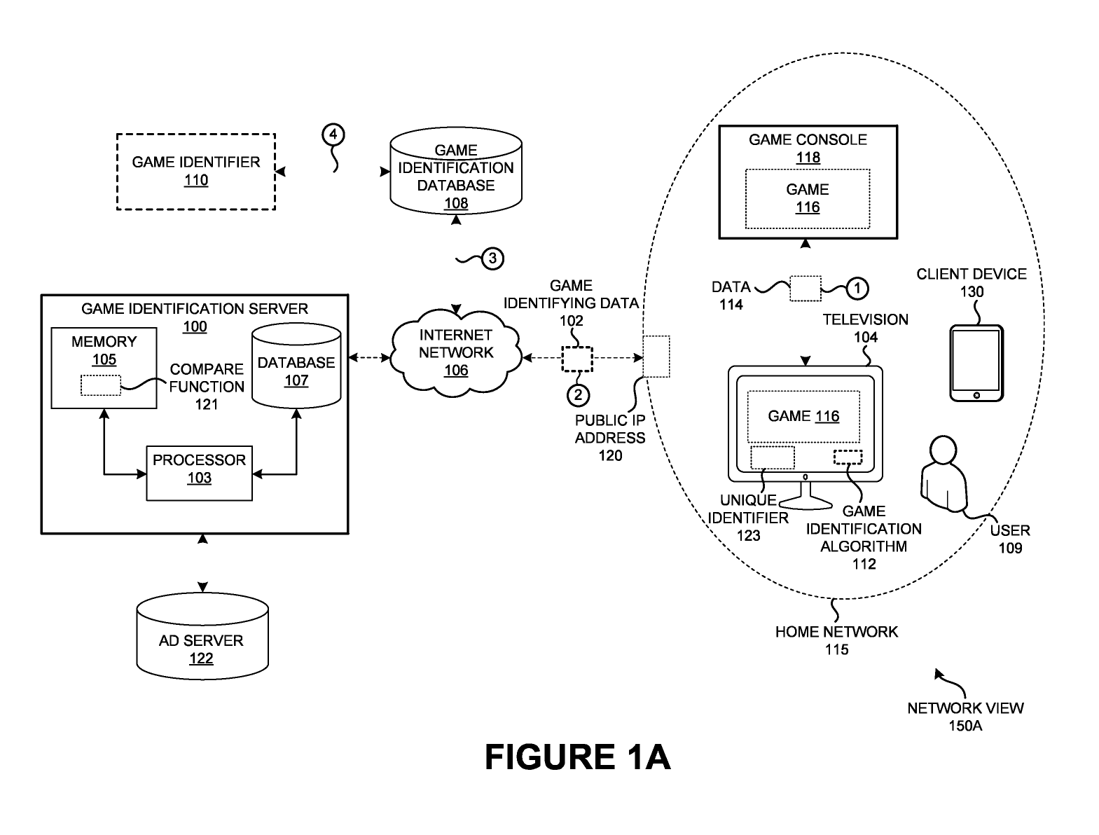

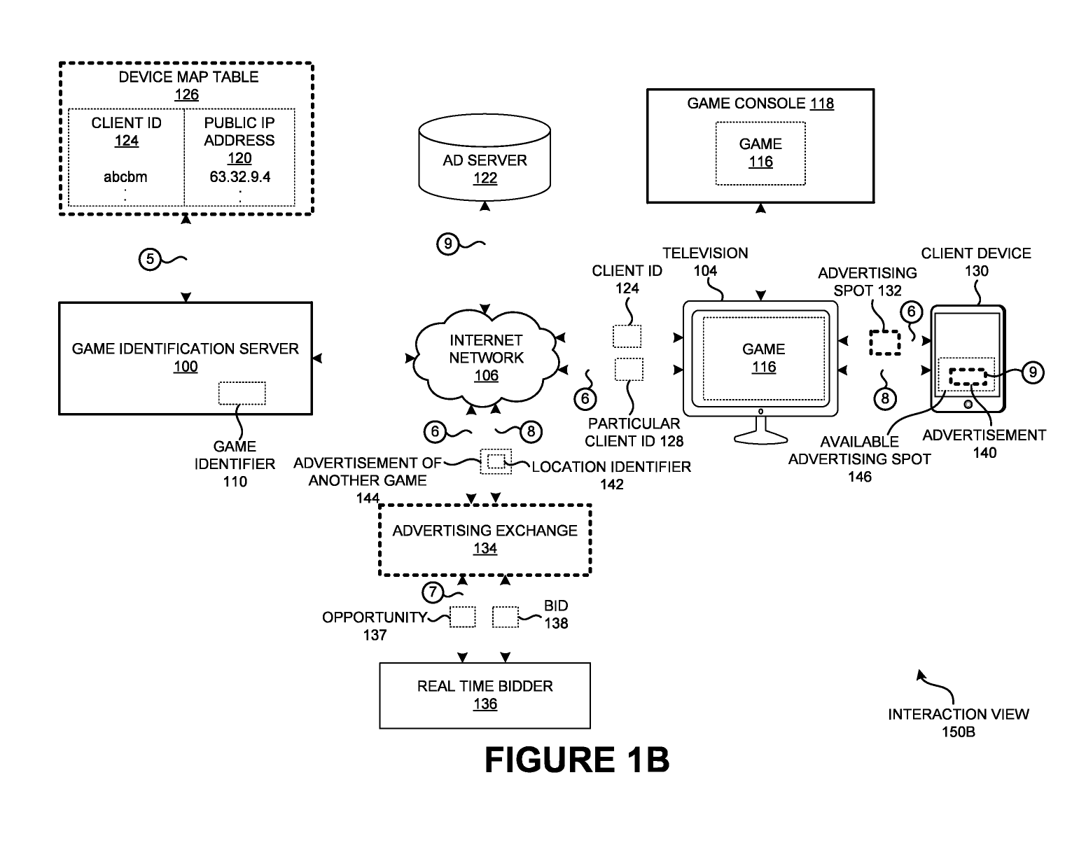

FIG. 1A is a network view 150A of a game identification server 100 illustrating the comparing of a game identifying data 102 received from a television 104 through an Internet network 106 with a game identification database 108 to determine a game identifier 110 associated with the game identifying data 102 while a game 116 is being played through a game console 118 communicatively coupled with the television 104, according to at least one embodiment. Particularly, FIG. 1A illustrates a game identification server 100, a game identifying data 102, a processor 103, a television 104, a memory 105, an Internet network 106, a database 107, a game identification database 108, a user 109, a game identifier 110, a game identification algorithm 112, a data 114, a home network 115, a game 116, a game console 118, a public IP address 120, a compare function 121, an ad server 122, a unique identifier 123, and a client device 130, according to one embodiment.

The game identification server 100 may be a computer program designed to process requests of specialized applications (e.g., electronic games, video games, virtual games) and deliver data to other (client) computers and/or its users (e.g., gamers, user 109) after authenticating their unique identification over a local network or the Internet. The game identifying data 102 may be distinct pieces of information, usually formatted in a special way to assign an identifier to a computer game of the game identification server 100, according to one embodiment. The processor 103 may be a logic circuitry that responds to and processes the basic instructions that drives the game identification server 100.

The television 104 may be an electronic broadcast system in which special providers transmit a continuous program of video content to the public or subscribers by way of antenna, cable, or satellite dish, often on multiple channels. The Internet network 106 may be a single worldwide computer network that interconnects other computer networks, on which end-user services, such as World Wide Web sites or data archives, are located, enabling data and other information to be exchanged, according to one embodiment.

The memory 105 may be an electronic holding place for instructions and data that microprocessor of the game identification server 100 can reach quickly. For example, in one embodiment, the memory may contain the compare function 121.

The Internet network 106 may be a global system of interconnected computer networks that use the standard Internet protocol suite (TCP/IP) to link several billion devices worldwide.

The database 107 may be a collection of information organized in such a way that a computer program (e.g., processor 103) can quickly access, select, manage, and update desired pieces of data, according to one embodiment.

The game identification database 108 may be a collection of information, for each game that can be uniquely identified distinguishing it from others, organized in such a way that a computer program and/or the game identification server 100 can quickly access, select, manage, and update desired pieces of data for each computer game. The game identifier 110 may be a name of a program and/or the names of the variables within a program that are used to identify the relevant data/info for a computer game (e.g., game 116), according to one embodiment.

The user 109 may be a person, device, process, and/or system that controls the functioning of the game console 116. For example, according to one embodiment, the user 109 may be a person playing the game 116 using the game console 118.

The game identifier 110 may be may be a feature associated with the game 116 that differentiates the game 116 from other games. For example, according to one embodiment, the game identifier 110 may be a game name, a stock keeping unit, a game genre, an age group, a game version, and/or a game language. The game identification algorithm 112 may be a self-contained set of operations to be performed to recognize a game 116 of the game identification server 100. For example, in one embodiment the game identification algorithm may be an automatic content recognition (ACR) algorithm. The game identification algorithm 112 may enable the television to 104 generate the game identifying data 102 based on the data 114 provided to the television 104. The data 114 may be a collection of information provided to the television 104 while a game 116 is being played that can be analyzed and/or used in an effort to make decisions. For example, according to one embodiment, the data may be an audio, a video, and/or a metadata generated by the game and/or the game console. In a further embodiment, the metadata may be HDMI-CEC.

The home network 115 may be a group of computers and associated devices connected to a server using a shared common communications line or wireless link. For example, according to one embodiment, the home network may span one or more Local Area Networks (LANs).

The game 116 may be a structured playing, usually undertaken for enjoyment and sometimes used as an educational, using a computing device and a television (e.g., television 104), according to one embodiment. The game console 118 (e.g., handheld game console, home console, etc.) may be a device that enables a form of interactive multimedia (e.g., video games, multiplayer games, action games, strategy games, virtual games) used for entertainment. The game console 118 may include audio visual data comprised of manipulable images (usually sounds, video, and special effects controllable through a joystick or control device connected to the game console 118 that is operated by the user 109) generated by a video signal and displayed on the television 104 and/or a similar audio-video system. An output video signal or visual image to display a video game (e.g., game 116) may be relayed by the game console 118. The player (e.g., user 109) may interact with the game through a controller (e.g., a hand-held device with buttons and joysticks and/or pads). The video and sound may be received by the gamer (e.g., user 109) through the television 104. The public IP address 120 may be any valid address and/or a number (e.g., an identifier), that can be accessed over the Internet. The public IP address 120 may be designated for use in a public domain, according to one embodiment.

The compare function 121 may be a named section of a program that performs a specific task of differentiating game identifying data 102 received from a television 104 through an Internet network 106 with a game identification database 108 to determine a game identifier 110 associated with the game identifying data 102. For example, according to one embodiment, the compare function 121 may be contained in the memory 105 of the game identification server 100.

The ad server 122 may be a computer program designed to process requests of specialized applications for advertising and deliver data to other (client) computers (e.g., game identification server 100) over a local network or the Internet. The unique identifier 123 may be a feature associated with the television 104 that differentiates the television 104 from other televisions and/or devices. For example, according to one embodiment, the unique identifier 123 may be a MAC address.

The client device 130 may be any device (e.g., a tablet, a mobile phone, an Internet enabled appliance, a desktop computer, and/or a television 104) communicatively coupled to the game console 118 used to play the game 116, according to one embodiment.

The game console 118 may be communicatively coupled with the television 104. The client device 130 may be communicatively coupled to the television 104 through the local area network (LAN) 115. The game identification server 100 may be communicatively coupled with the television 104 through the Internet network 106. The game identification server 100 may be coupled to the game identification database 108 through the Internet network 106. The ad server 122 may be coupled with the game identification server 100, according to one embodiment.

In circle ‘1’, the data 114 may be provided to the television 104 by the game console 118 while the game 116 is being played using the game console 118. In circle ‘2’, the game identifying data 102 may be generated using the game identification algorithm 112 of the television 104. In circle ‘3’, game identifying data 102 received from the television 104 through the Internet network 106 may be compared (e.g., using the compare function 121 of the game identification server 100) with the game identification database 108 to determine a game identifier 110 associated with the game identifying data 102. In circle ‘4’, the game identifier 110 may be associated with the public IP address 120 of the television 104 and/or the unique identifier 123 of the television 104, according to one embodiment.

FIG. 1B is an interaction view 150B of a real time bidder 136 being presented with an opportunity 137 to place a bid 138 for an advertisement 140 to the client device 130 associated with a particular client ID 128 associated with the game identifier 110 of the game identification server 100 of FIG. 1A, according to at least one embodiment. Particularly, FIG. 1B illustrates a client ID 124, a device map table 126, a particular client ID 128, an advertising spot 132, an advertising exchange 134, a real time bidder 136, an opportunity 137, a bid 138, an advertisement 140, a location identifier 142, an advertisement of another game 144, and an available advertising spot 146, according to one embodiment.

The client ID 124 may be a logical entity used to identify a user on a software, system, and website or within any generic IT environment. It may be used within any IT enabled system to identify and distinguish between the users who access or use it. The client ID 124 may be the logical entity associated with the public IP address 120 of the television 104 that is used to identify the device (e.g., a tablet, a mobile phone, an Internet enabled appliance, and/or a desktop computer) used for playing the game 116 of game identification server 100. The device map table 126 may be a data structure used to organize information associating the client ID 124 with the public IP address 120 of the television 104 and/or client device 130 associated with the game identifier 110, according to one embodiment.

The particular client ID 128 may be a specific client ID 124 received from a client device 130 associated with the game identifier 110. The advertising spot 132 may be a particular place available for displaying a notice or an announcement in a public medium (e.g., television 104) for promotion of a game (e.g., game 116). The advertising exchange 134 may be a platform where advertising spot 132 may be traded for promotion of a game (e.g., game 116), according to one embodiment.

The real time bidder 136 may be the person and/or an organization offering to pay for an opportunity 137 to place an advertisement 140 for promoting a game (e.g., game 116) at the same rate and same time at which the client device 130 provides an advertising spot 132. The advertising exchange 134 may target advertising opportunities to real time bidders (e.g., the real time bidder 136) that previously expressed an interest in the client ID 124. The opportunity 137 may be a time or set of circumstances that makes it possible to offer placing a notice or announcement in a public medium (e.g., television 104) for promoting a service and/or a product (e.g., game 116). The bid 138 may be an offer of a price for advertisement 140 of a game, especially at an auction, according to one embodiment.

The advertisement 140 may be a notice or announcement in a public medium for promoting a service and/or a product (e.g., another game 212). The location identifier 142 may be a Uniform Resource Locator 304 code for an advertisement of another game 144. The advertisement of another game 144 may be a notice or announcement in a public medium for promoting an additional and/or a second game (e.g., another game 212). The available advertising spot 146 may be a particular place at user's (e.g., user 109) disposal where a notice or an announcement may be displayed in a public medium (e.g., television 104) for promotion of the game 116, according to one embodiment.

The game identification server 100 may be communicatively coupled with the advertising exchange 134 through the Internet network 106. The real time bidder 136 may be communicatively coupled with the advertising exchange 134 through the Internet network 106. The device map table 126 may be coupled with the game identification server 100, according to one embodiment.

In circle ‘5’, the client ID 124 associated with the public IP address 120 using the device map table 126 is determined. In circle ‘6’, the client device 130 associated with the particular client ID 128 associated with the game identifier 110 may provide the advertising spot 132 to the advertising exchange 134. In circle ‘7’, the advertising exchange 134 may provide an opportunity 137 to a real time bidder 136 to place a bid 138 for an advertisement 140 to be placed in the advertising spot 132. In circle ‘8’, the location identifier 142 of the advertisement of another game 144 to the game 116 associated with the game identifier 110 may be provided to the client device 130 providing the advertising spot 132 upon successfully winning the bid 138 from the advertising exchange 134. In circle ‘9’, the advertisement 140 may be placed on the available advertising spot 146 on the client device 130 when the client device 130 accesses an ad server 122 having the advertisement 140 through the location identifier 142, according to one embodiment.

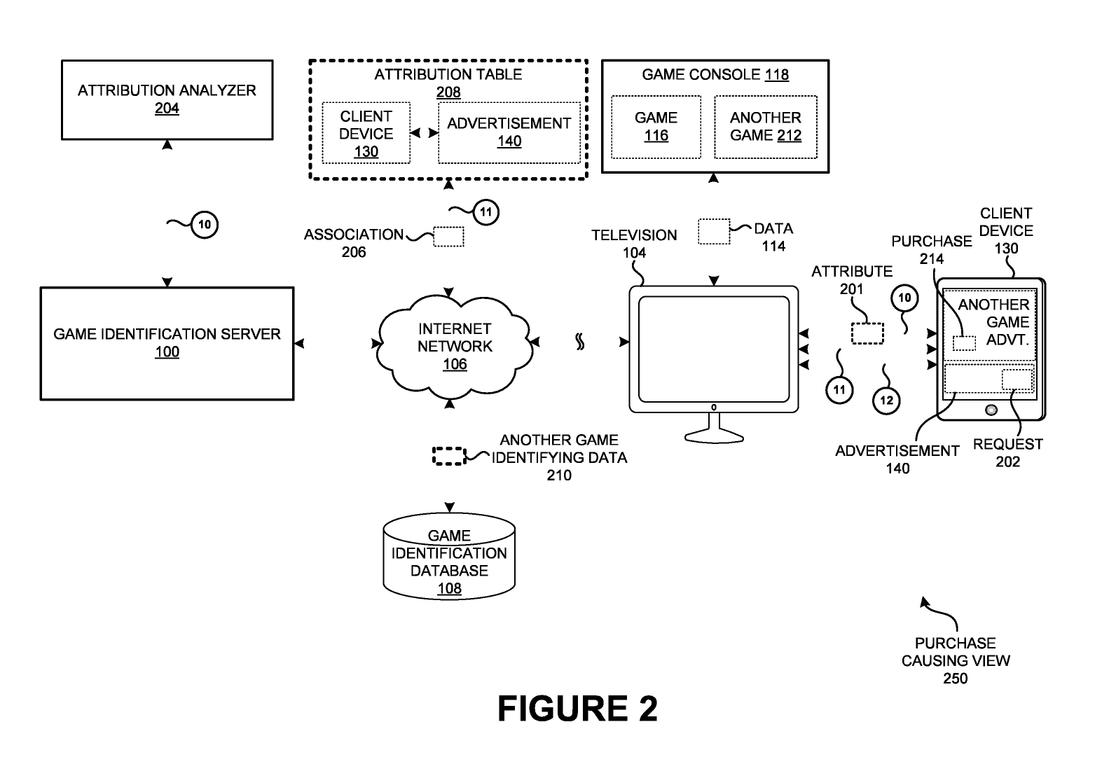

FIG. 2 is a purchase causing view 250 illustrating the effecting of a purchase 214 of an another game 212 after determining that the client device 130 displayed the advertisement 140 based on an association 206 of the advertisement 140 with the client device 130 in an attribution table 208 of game identification server 100 FIG. 1A, according to at least one embodiment. Particularly, FIG. 2 illustrates an attribute 201, a request 202, an attribution analyzer 204, an association 206, an attribution table 208, an another game identifying data 210, an another game 212, and a purchase 214, according to one embodiment.

The attribute 201 may be a specification that defines a property of an object, element, or file (e.g., game 116). It may also refer to or set the specific value for a given instance of such (e.g., an event and/or an occurrence). Attribute 201 may be considered a metadata of the game 116. The request 202 may be an act of asking formally to display the advertisement 140 on the client device 130. The attribution analyzer 204 may be a program and/or a device used for detailed systematic examination and evaluation of data and/or information, by breaking it into its component parts to uncover their interrelationships and identifying a set of user actions (“events”) that contribute in some manner to a desired outcome, and then assigning a value to each of these events while a game 116 is being played using the game console 118. In one embodiment, the client device 130 may not know its public IP address 120. For example, if there is a Network Address Translator (NAT) device between the client device 130 and the Internet network 106, then the NAT may replace the IP address of the client device 130 with a public IP address assigned to the NAT. According to one embodiment, the attribution analyzer 204 may be a device that processes a set of user actions (“events”) that contribute in some manner to a desired outcome, and then assigning a value to each of these events while the game 116 is being played through the game console 118 communicatively coupled with the television 104. In another embodiment, the attribution analyzer 204 may receive a log of game events (e.g., the game event 716) from advertisement data providers (e.g., the game identification server 100 and/or the advertisers) that have collected exposures to advertisements (e.g., the advertisement 140) so that the attribution analyzer 204 may find client IDs (e.g., the client ID 124) of exposures to the advertisement 140 that occurred prior to those client IDs associating with game plays for the game 116. The association 206 may be a connection or cooperative link between the advertisement 140 with the client device 130, according to one embodiment.

The attribution table 208 may be a set of user actions (“events”) having assigned values and the criteria on which they are based that is used to place the association 206 of the advertisement 140 with the client device 130. The another game identifying data 210 may be distinct pieces of information, usually formatted in a special way to assign an identifier to an additional and/or a second computer game (e.g., another game 212). According to one embodiment, the another game identifying data 210 may be anything that could be generated by the game identification algorithm 112 (e.g., audio and/or video fingerprints.) The another game 212 may be an additional and/or a second game (e.g., newly released game, a similar game, a complementary game, and/or a related game) that may be exposed using the game console 118 communicatively coupled to the television 104, according to one embodiment.

The purchase 214 may be the process of determining the likely acquisition of another game 212 when it is determined that the client device 130 displayed the advertisement 140 based on the association 206 of the advertisement 140 with the client device 130 in the attribution table 208 and the another game identifier associated with the another game identifying data 210 is that of the another game 212, according to one embodiment. According to another embodiment, the purchase 214 may be a verified play (e.g., a game rental, an online-subscription, and/or an ad-supported game.)

The game identification server 100 may be coupled with the attribution table 208 through the Internet network 106. The attribution analyzer 204 may be coupled with the game identification server 100, according to at least one embodiment.

In circle ‘10’, the client device 130 may communicate the attribute 201 (e.g., public IP address 120, client ID 124, and/or an ad id 312), to an attribution analyzer 204 of the game identification server 100. In circle ‘11’, an association 206 of the advertisement 140 with the client device 130 may be placed in an attribution table 208. In circle ‘12’, the advertisement 140 likely caused a purchase 214 of the another game 212 may be determined based on the association 206 of the advertisement 140 with the client device 130 in the attribution table 208 when it is determined that the client device 130 displayed the advertisement 140, according to one embodiment.

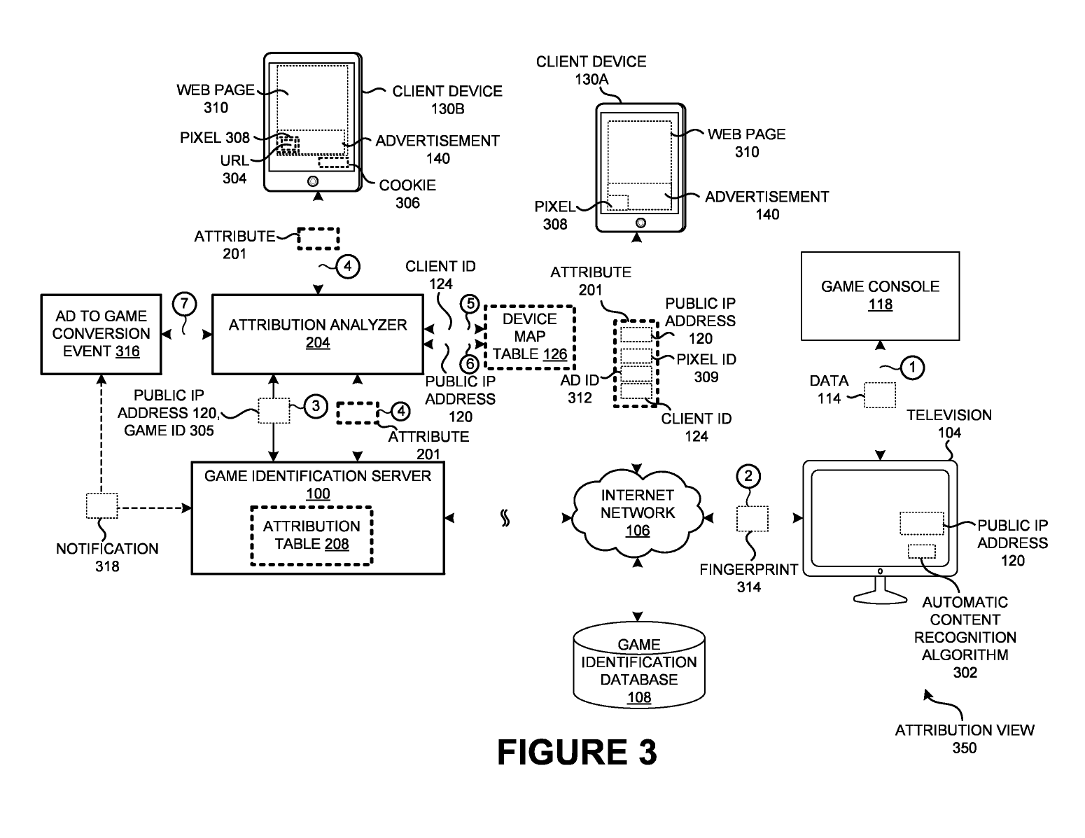

FIG. 3 is an attribution view 350 of the client device 130 associated with the game console 118 of the game identification server of FIG. 1A, according to at least one embodiment. Particularly, FIG. 3 illustrates an automatic content recognition (ACR) algorithm 302, a URL 304, a game ID 305, a cookie 306, a pixel 308, a web page 310, an ad ID 312, a fingerprint 314, an ad to game conversion event 316, and a notification 318, according to one embodiment.

The ACR algorithm 302 may be a process or set of rules to be followed in calculations or other problem-solving operation to identify a content element, audio, video or digital image, by a client application (typically a smartphone or media tablet app), based on sampling a portion of the audio or video (or image), processing the sample and comparing it with a source service that identifies content by its unique characteristics such as audio (e.g., audio fingerprint 508) or video fingerprints (e.g., video fingerprint 510) and/or watermarks, according to one. The URL 304 may be a unique address for a file (e.g., advertisement 140) that is accessible on the Internet. The game ID 305 may be a logical entity used to identify the game 116 of the game identification server 100, according to one embodiment.

The cookie 306 may be a message (e.g., request 202) given to a Web browser by a Web server. The cookie 306 may include the client ID 124 of the client device 130 and communicate the client ID 124 to the attribution analyzer 204 of the game identification server 100 and possibly prepare customized Web pages for the user 109 playing the game using game console 118, according to one embodiment. In another embodiment, the cookie 306 may be communicated to the attribution analyzer 204 in order to track exposures to advertisements (e.g., the advertisement 140), In a further embodiment, the cookie 306 may be communicated to the advertising exchange 134 along with the available advertising spot 146 enabling the advertising exchange 134 to know which client ID (e.g., the client ID 124) to lookup in its hosted match table (e.g., the device map table 126) in order to determine which real time bidders (e.g., the real time bidder 136) might be interested. The advertising exchange 134 may forward the client ID 124 to the real time bidder 136 so that the real time bidder 136 can associate the client device 130 with available data (e.g., a list of game identifiers associated with the client ID 124 obtained from the game identification server 100.) In yet an additional embodiment, the cookie 306 may be communicated to the game identification server 100. In a further embodiment, the client device 130 may communicate the cookie 306 to the attribution analyzer 204 and, in the case of Google® GIDs, the web page may contain a URL to a Google® web API that will redirect back to Samba.TV (or any party registered with Google® and specified in the URL to Google's® web API), and the HTTP redirection can be to any arbitrary URL, thereby allowing Google® to redirect to samba.tv and append key-value pairs to the query string of the URL that contain any state that had been cookied in Google's® domain including the DoubleClick® ID associated with the client device 130.

The pixel 308 may be a single point in a graphic image (e.g., advertisement 140) having an embedded image Uniform Resource Locator (URL) 304 that refers to the attribution analyzer 204. The web page 310 may be a document on the World Wide Web, consisting of a hypertext file and/or any related files (e.g. advertisement 140) for scripts and graphics, and often hyperlinked to other documents on the Web. The ad ID 312 may be a logical entity used to identify an advertisement 140 of the game identification server 100, according to one embodiment.

The fingerprint 314 may be a procedure that maps an arbitrarily large data item (e.g., data 114), such as a computer file, to a much shorter bit string that uniquely identifies the original data for all practical purposes. For example, according to one embodiment, the fingerprint 314 may be generated by the ACR algorithm 302. The ad to game conversion event 316 may be an occurrence of purchase 214 and/or exposure of an advertisement 140 to the user 109 when the user 109 clicks on the URL 304 provided in the advertisement 140. In another embodiment, the exposure of an advertisement 140 may be determined without the user 109 clicking on the URL 304 provided in the advertisement by including a pixel 308 with the advertisement 140 wherein the pixel 308 is an IMG tag with a URL pointing to the attribution analyzer 204 and/or to an entity that can obtain a client ID 124 (e.g., via a cookie 306.) In a further embodiment, an exposure may be determined wherein a broadcast advertisement (e.g., the advertisement 140) converts to a game play. The notification 318 may be the communication of occurrence of ad to game conversion event 316 by the attribution analyzer 204 to the game identification server 100 when the user 109 accesses the advertisement 140 through the URL 304 provided in the advertisement 140, according to one embodiment.

The client device 130A and client device 130B may be communicatively coupled with the game identification server 100 through the Internet network 106. The attribution analyzer 204 may be coupled with the game identification server 100. The device map table 126 may be coupled with the attribution analyzer 204, according to one embodiment.

In circle ‘1’, the data 114 may be provided to the television 104 while a game 116 is being played through a game console 118 communicatively coupled with the television 104. In circle ‘2’, the fingerprint 314 of the data 114 provided from the game console 118 to the television 104 may be generated by the ACR 302. In circle ‘3’, the public IP address 120 and game ID 305 may be communicated to the attribution analyzer 204. In circle ‘4’, the attribute 201 (e.g., the pixel ID 309, client ID 124, and/or the ad id 312) of the client device 130A and client device 130B may be communicated to the attribution analyzer 204. In circle ‘5’, the attribution analyzer 302 may associate the client ID 124 with the advertisement 140 using the device map table 126. In circle ‘6’, the game identification server 100 may automatically identify the users who are exposed to the advertisement 140 versus users who are not exposed to the advertisement 140 (e.g., client device 130A and/or client device 130B) through the attribution analyzer 204. In circle ‘7’, occurrence of purchase 214 and/or exposure of an advertisement 140 to the user 109 may be notified to the game identification server when the user 109 clicks on the URL 304 provided in the advertisement 140, according to one embodiment.

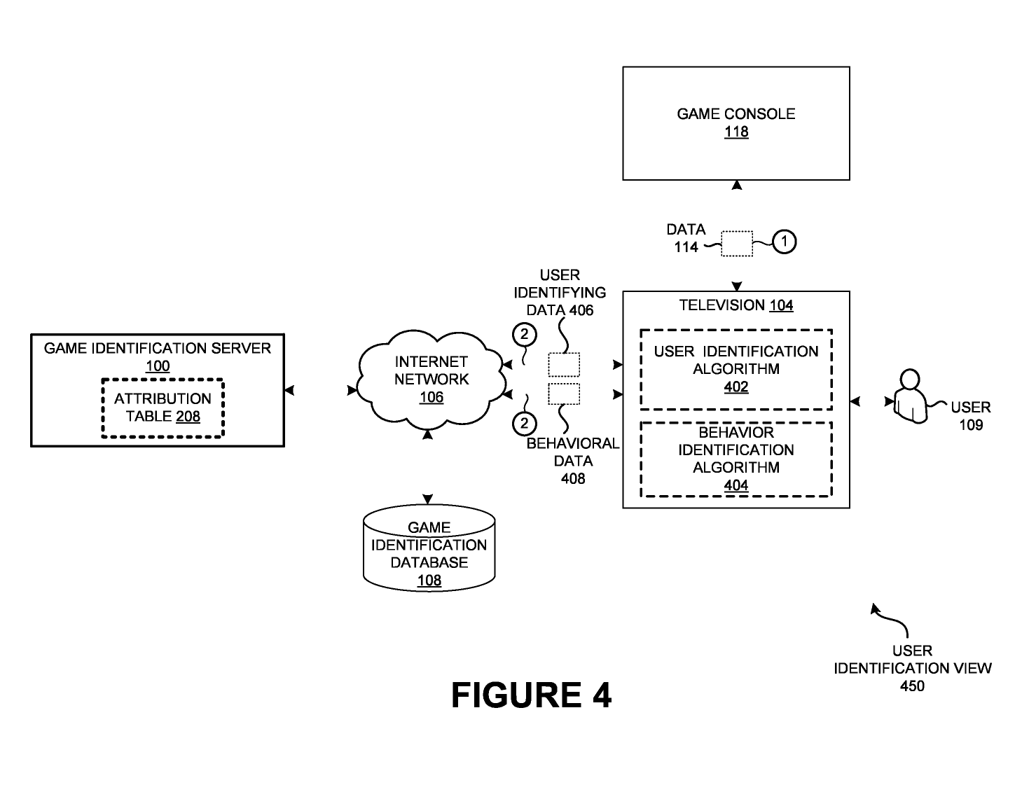

FIG. 4 is a user identification view 450 illustrating the generation of user identifying data 406 using the user identification algorithm 402 of the television 104 of game identification server 100 of FIG. 1A, according to at least one embodiment. Particularly, FIG. 4 illustrates a user identification algorithm 402, a behavior identification algorithm 404, a user identifying data 406, and a behavioral data 408, according to one embodiment.

The user identification algorithm 402 may be a process or set of rules to be followed in calculations or other problem-solving operation of uniquely identifying a user 109 while a game 116 is being played through the game console 118. The behavior identification algorithm 404 may be a process or set of rules to be followed in calculations or other problem-solving operation of uniquely identifying a user behavior while a game 116 is being played through the game console 118, according to one embodiment.

The user identifying data 406 may be distinct pieces of information, usually formatted in a special way, to assign an identifier to a user 109 while a game 116 is being played through the game console 118. The user identifying data 406 may be generated using a user identification algorithm 402. In one embodiment, the user identifying data 406 may be communicated to the real time bidder 136 and/or to the attribution analyzer 204. The real time bidder 136 may use the user identifying data 406 to lookup demographic data and/or to control the reach and/or the frequency of exposures among the various household members, according to a further embodiment. In an additional embodiment, the user identifying data 406 may be combined with various data associated with a particular client ID thereby allowing the targeting of client devices (e.g., the client device 130) of the game player(s) (e.g., the user 109) within the household (e.g., within the home network 115.) According to another embodiment, the user identification data 406 may be used for attribution and/or advertisement targeting. In a further embodiment, the user identifying data 406 may be used to correlate game plays to specific client devices (e.g., the client device 130) in order to more accurately determine whether a person exposed to the advertisement 140 is actually the person that plays the game 116 (e.g., the user 109.) In another embodiment, the user identifying data may be used to lookup demographic information that may be used to determine types of people that are converted from exposure into actual game play.

The behavioral data 408 may be the distinct information collected using the user identification algorithm 402 based on the data 114 provided to the television 104 while the game 116 is being played through the game console 118 communicatively coupled with the television 104 for each user 109. The behavioral data 408 may include a length of game play, a stopping location of the game, a level of the game, how often the game is played, and how long the game is played, according to one embodiment. In another embodiment, the behavioral data 408 may be used for attribution and/or advertisement targeting and may be communicated to the real time bidder 136 and/or the attribution analyzer 204. The real time bidder 136 may use the behavioral data 408 may be used as targeting information when the real time bidder 136 decides which client IDs to target, according to an additional embodiment. In a further embodiment, the behavioral data 408 may be used by the attribution analyzer 204 to determine the verified play rate among people that meet certain behavioral criteria.

In circle ‘1’, the data 114 may be provided to the television 104 while a game 116 is being played through a game console 118 communicatively coupled with the television 104. In circle ‘2’, user identifying data 406 may be generated using the user identification algorithm 402 of the television 104. In addition, behavioral data 408 may be generated using the behavior identification algorithm 404 of the television 104 for each user 109 identified, according to one embodiment.

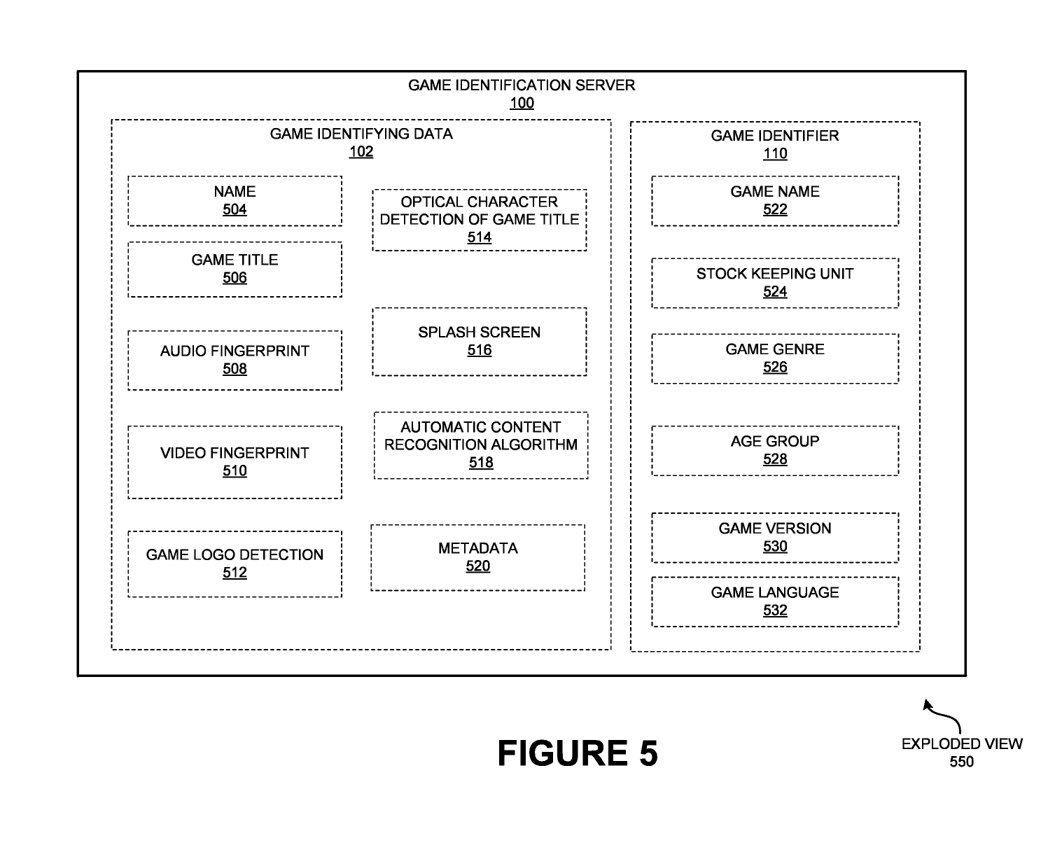

FIG. 5 is an exploded view 550 of game identification server 100 of FIG. 1A, according to at least one embodiment. Particularly, FIG. 5 a name 504, a game title 506, an audio fingerprint 508, a video fingerprint 510, a game logo detection 512, an optical character detection of game title 514, a splash screen 516, an automatic content recognition data 518, a metadata 520, a game name 522, a stock keeping unit 524, a game genre 526, an age group 528, a game version 530, and a game language 532, according to one embodiment.

The name 504 may be a denomination and/or a title by which a game is referred to. The game title 506 may be a word or combination of words by which a particular game is regularly known and/or referred to, according to one embodiment.

The audio fingerprint 508 may be a condensed digital summary of attributes of sound (e.g., attribute 201), deterministically generated from an audio signal that can be used to identify an audio sample and/or quickly locate similar items in an audio database (e.g., game identification database 108). The video fingerprint 510 may be a summary of the attributes of a video file, video sequence, video frame, and/or subset of a video frame (e.g., attribute 201) that is used to identify video within the game 116 using game console 118, according to one embodiment.

The game logo detection 512 may be the process of recognizing a symbol and/or other small design adopted by an organization (e.g., real time bidder 136) to identify its games distinguishing it from others. The optical character detection of game title 514 may be the mechanical and/or electronic conversion of images of typewritten or printed game title 506 into machine-encoded text. The splash screen 516 may be a graphical control element consisting of window containing a video, an image, a logo and/or the current version of the software. For example, according to one embodiment, the splash screen 516 may be a short video sequence that contains a logo or a title. The splash screen 516 may usually appear while the another game 212 (e.g., a newly released game, a similar game, a complementary game, and/or a related game) is launching, according to one embodiment.

The automatic content recognition data 518 may be content element(s) and/or audio, video or digital image(s), that may be identified by a client application (typically a smartphone or media tablet app), based on sampling a portion of the audio or video (or image), processing the sample and comparing it with a source service that identifies content by its unique characteristics such as audio (e.g., audio fingerprint 508) or video fingerprints (e.g., video fingerprint 510) and/or watermarks, according to one embodiment. For example, in a further embodiment, the automatic content recognition data may be identified and/or generated by the ACR algorithm 302.

The metadata 520 may be a data that serves to provide context or additional information about other data (e.g., data 114). The game name 522 may be a denomination, a title, and/or a name and/or the names of the variables within a program that are used to identify the relevant data/info of a computer game (e.g., game 116). The stock keeping unit 524 may be a store's or catalog's product (e.g., game 116) and service identification code, often portrayed as a machine-readable bar code that helps the item to be tracked for inventory, according to one embodiment.

The game genre 526 may be a class or category of artistic endeavor having a particular form, content, or technique of the game 116. The age group 528 may be the duration or the length of time for which the game 116 can be played. The game version 530 may be a particular form of the game 116 differing in certain respects (e.g., a type, a format, a variance) from an earlier form or other forms of the same type of game (e.g., game 116). The game language 532 may be the structured conventional written words used to identify the relevant data/info of a game (e.g., game 116), according to one embodiment. According to one embodiment, the game genre 526, the age group 528, the game version 530, and/or the game language 532 may be made available to the real time bidder 136 for use in making bid decisions.

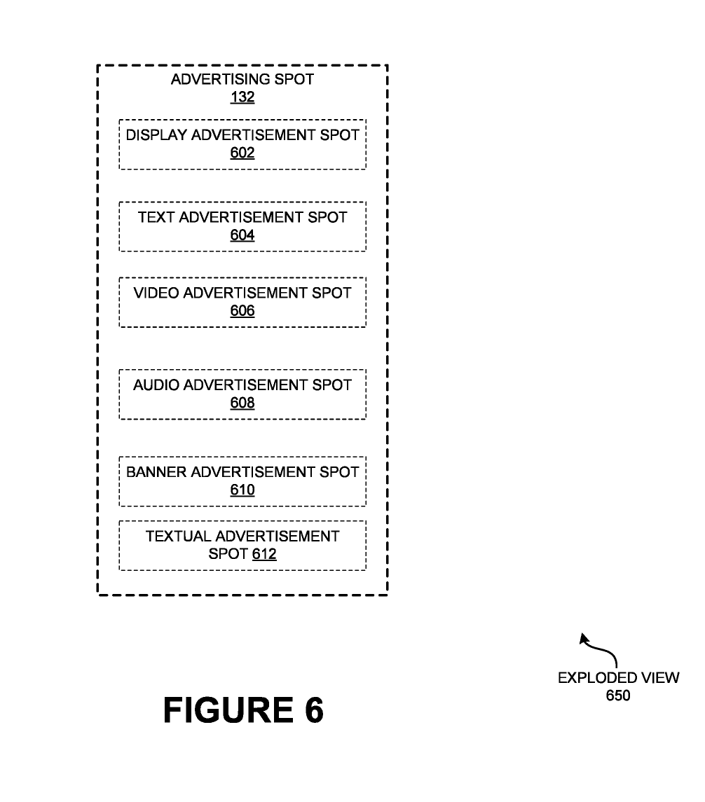

FIG. 6 is an exploded view 650 of an advertising spot 132 of the game identification server 100 of FIG. 1A, according to at least one embodiment. Particularly, FIG. 6 illustrates a display advertisement spot 602, a text advertisement spot 604, a video advertisement spot 606, an audio advertisement spot 608, a banner advertisement spot 610, and a textual advertisement spot 612, according to one embodiment.

The display advertisement spot 602 may be a particular place where a notice or an announcement may be displayed in a web page (e.g., web page 310) for promotion of a game (e.g., game 116). The text advertisement spot 604 may be a particular place designated for a notice or an announcement in a textual form may be displayed in a web page (e.g., web page 310) for promotion of a game (e.g., game 116). The video advertisement spot 606 may be a particular place designated for a promotional film in a web page (e.g., web page 310) for promotion of a game (e.g., game 116), according to one embodiment.

The audio advertisement spot 608 may be a particular place designated for a notice or an announcement in an auditory form in a web page (e.g., web page 310) for promotion of a game (e.g., game 116). The banner advertisement spot 610 may be typically a rectangular advertisement placed on a Web site above, below or on the sides of the Web site's main content and is linked to the advertiser's own Web site for promotion of a game (e.g., game 116). The textual advertisement spot 612 may be a particular place designated for a notice or an announcement to be displayed in a scripted form in a web page (e.g., web page 310) for promotion of a game (e.g., game 116), according to one embodiment.

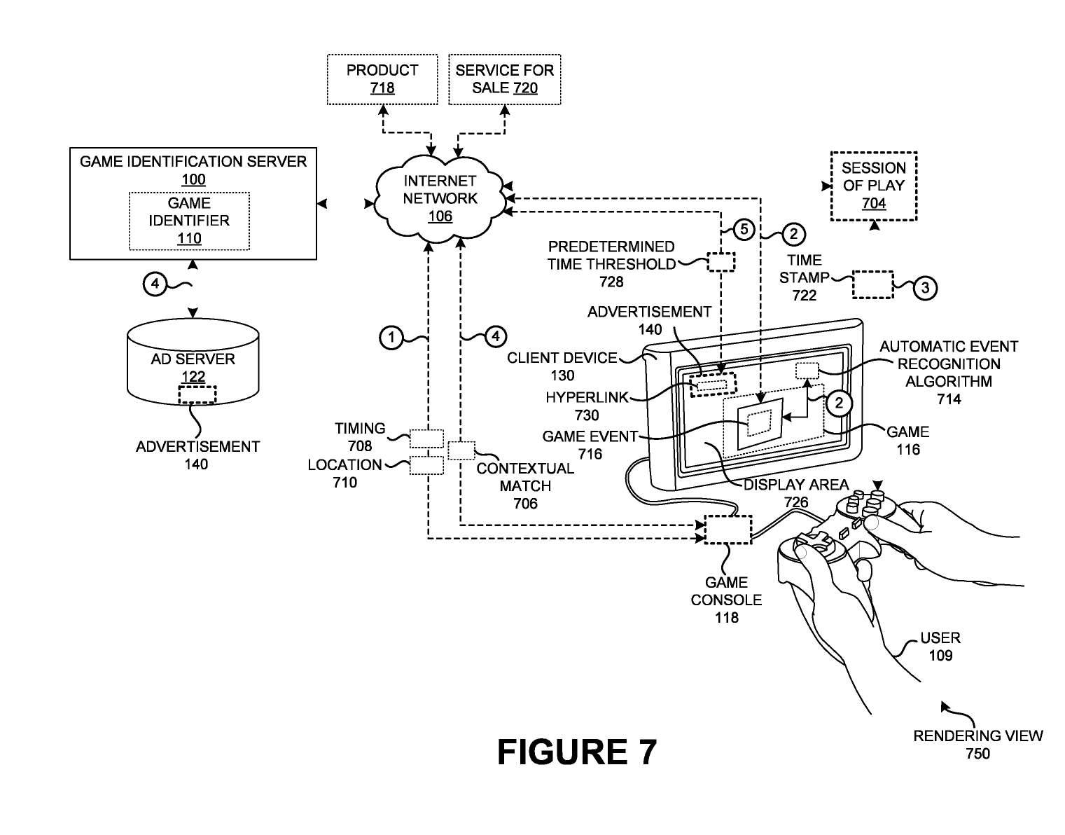

FIG. 7 is a rendering view 750 illustrating the selection of an advertisement 140 formatted for a display area 726 of the client device 130 that is associated with a game event 716 based on a contextual match 706 between the game event 716 and the advertisement 140 of the game identification server 100 of FIG. 1A, according to at least one embodiment. Particularly, FIG. 7 a session of play 704, a contextual match 706, a timing 708, a location 710, an automatic event recognition algorithm 714, a game event 716, a product 718, a service for sale 720, a time stamp 722, a display area 726, and a predetermined time threshold 728, according to one embodiment.

The session of play 704 may be the time period for which the game 116 is played on the game console 118. The contextual match 706 may be the circumstantial setting between the game event 716 and the advertisement 140 to qualify for selection of the advertisement 140 to be formatted for a display area 726 of the client device 130, according to one embodiment.

The timing 708 may be the measure of time period for which the game event 716 is rendered during the session of play 704. The location 710 may be the position of the game event 716 that is rendered during the session of play 704. The automatic event recognition algorithm 714 may be a preprogrammed process or set of rules to be followed in calculations or other problem-solving operation of identifying an event rendered during the session of play 704, according to one embodiment.

The game event 716 may be the appearance of an object, reaching a level, an amount of time played, and/or a number of times played rendered within the game that player (e.g., user 109) can see and interact with. The product 718 may be a commodity (e.g., another game 212) offered for sale. The service for sale 720 may be an assistance offered in exchange of money. The time stamp 722 may be a sequence of characters or encoded information identifying when a certain event occurred, usually giving date and time of day regarding the game event 716.

The display area 726 may be the region or part of an exhibit where the advertisement 140 can be exposed for viewing. The predetermined time threshold 728 may be the preset starting point of time stamp 722 by which time the advertisement 140 is delivered to the client device 130, according to one embodiment.

The game console 118 may be communicatively coupled with the client device 130. The client device 130 may be communicatively coupled with the game identification server 100 through the Internet network 106, according to one embodiment.

In circle ‘1’, the timing 708 and the location 710 of the game event 716 rendered during the session of play 704 by the user 109 of the game 116 in the game accessed through the game console 118 may be determined. In circle ‘2’, the automatic event recognition algorithm 714 may be applied to a game event 716 to determine that the game event 716 is associated with the product 718 and/or the service for sale 720. In circle ‘3’, the time stamp 722 may be associated with the session of play 704 and the timing 708 and the location 710 of the game event 716, according to one embodiment.

In circle ‘4’, the advertisement 140 formatted for the display area 726 of the client device 130 that is associated with the game event 716 may be selected based on a contextual match 706 between the game event 716 and the advertisement 140. In circle ‘5’, the advertisement 140 may be delivered to the client device 130 within the predetermined time threshold 728 of the time stamp 722 associated with the session of play 704 and the timing 708 and the location 710 of the game event 716, according to one embodiment.

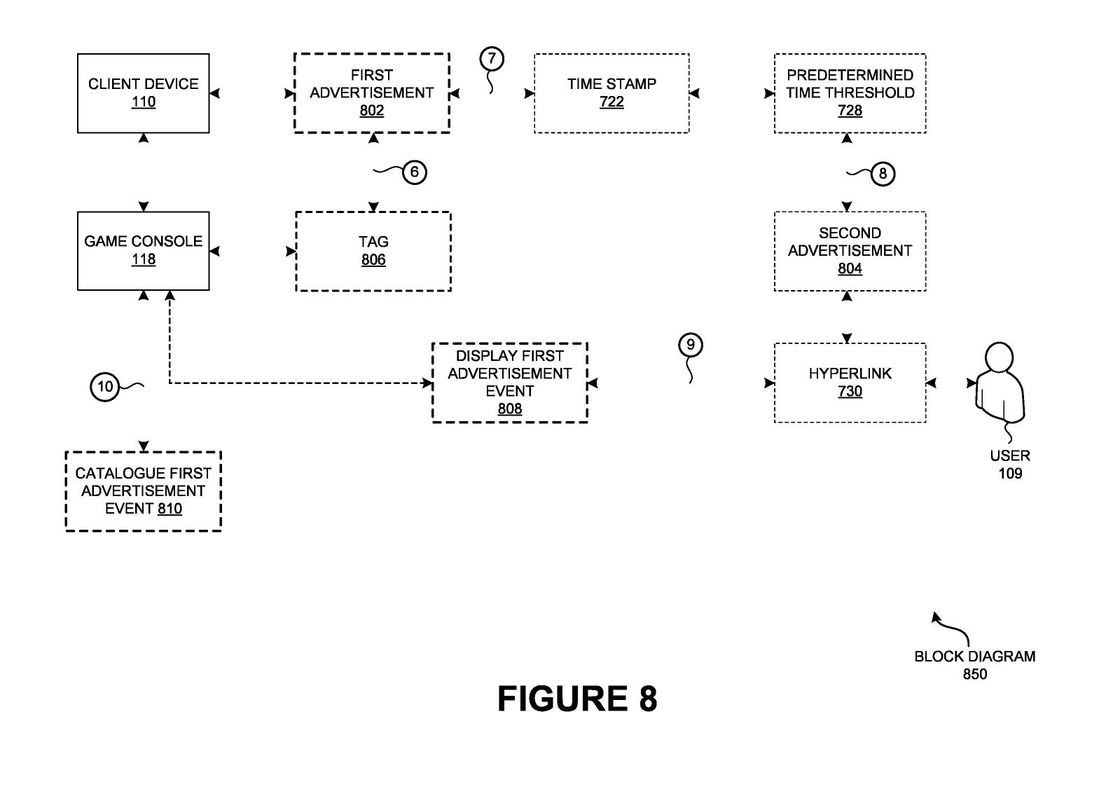

FIG. 8 is a block diagram illustrating the automatic cataloguing of first advertisement 802 of the game identification server 100 of FIG. 1A, according to at least one embodiment. Particularly, FIG. 8 illustrates a first advertisement 802, a second advertisement 804, a tag 806, a display first advertisement event 808, and a catalogue first advertisement event 810, according to one embodiment.

The first advertisement 802 may be the earliest advertisement 140 displayed on the television 104 by the game console 118. The second advertisement 804 may be the preprogrammed succeeding advertisement 140 targeted after display of first advertisement 802 to the client device 130 within the predetermined time threshold 728 of the time stamp 722. The tag 806 may be a label associated with the first advertisement 802 for identification. The display first advertisement event 808 may be the periodical display of the first advertisement 802 on the game console 118 based on the determination that the user 109 has interacted with the second advertisement 804 by selecting the hyperlink 730 in the second advertisement 804. The catalogue first advertisement event 810 may be the occurrence of systematic listing of the first advertisement 802, according to one embodiment.

In circle ‘6’, the first advertisement 802 may be automatically identified through a tag 806 associated with the first advertisement 802. In circle ‘7’, the time stamp 722 may be automatically associated with the first advertisement 802. In circle ‘8’, the second advertisement 804 may be automatically targeted to the client device 130 based on the first advertisement 802 and within the predetermined time threshold 728 of the time stamp 722. In circle ‘9’, the first advertisement 802 on the game console 118 may be periodically displayed based on the determination that the user 109 has interacted with the second advertisement 804 by selecting the hyperlink 730 in the second advertisement 804. In circle ‘10’, the first advertisement 802 may be automatically catalogued, according to one embodiment.

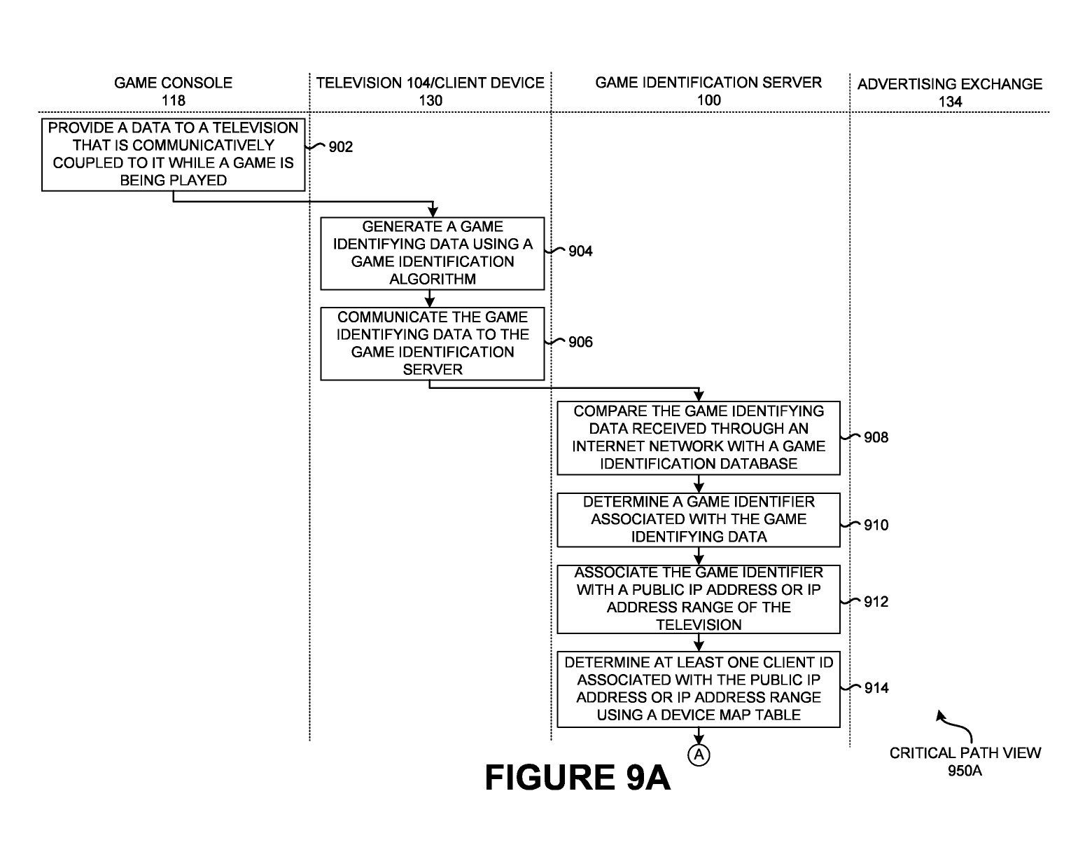

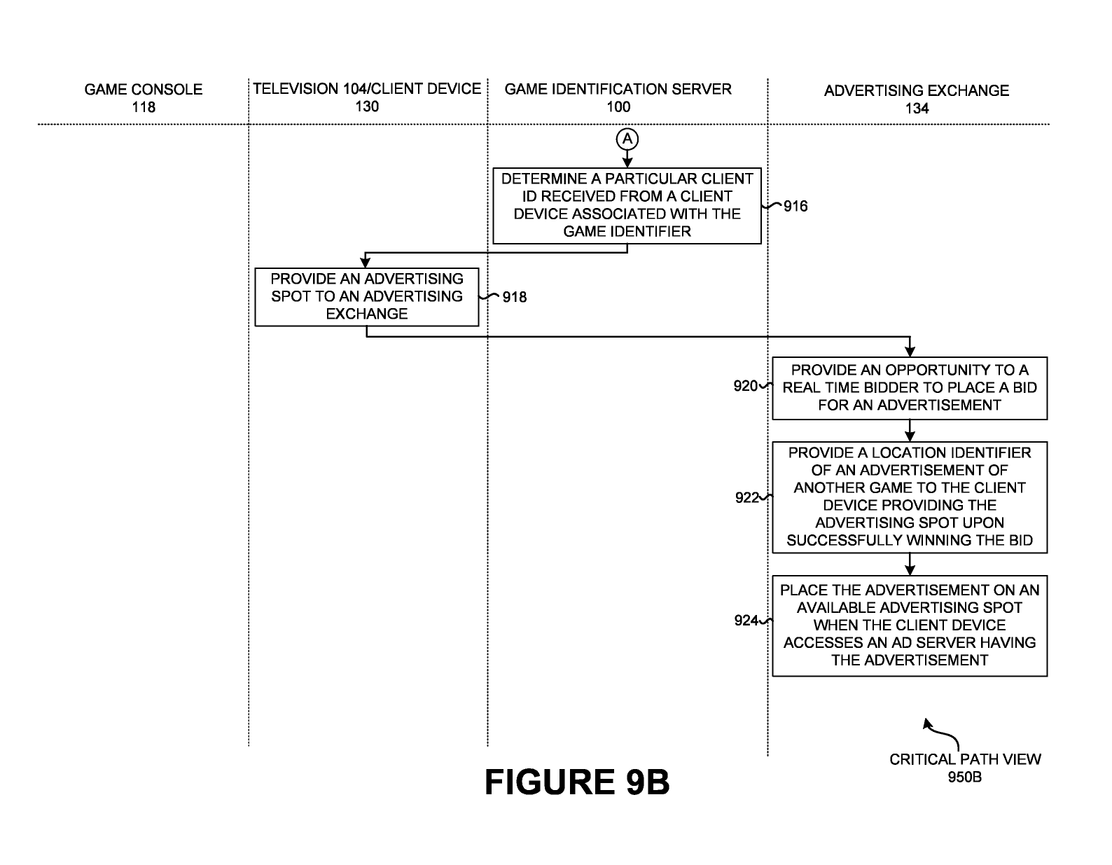

FIG. 9A is a critical path view 950A illustrating a flow based on time in which critical operations of the game identification server 100 of FIG. 1A will occur, according to at least one embodiment. In operation 902, the game console 118 may provide a data 114 to a television 104 that is communicatively coupled to it while a game 116 is being played. In operation 904, the television 104 may generate a game identifying data 102 using a game identification algorithm 112. In operation 906, the television 104 may communicate the game identifying data 102 to the game identification server 100. In operation 908, the game identification server 100 may compare (e.g., using the compare function 121 of game identification server 100) the game identifying data 102 received through an Internet network 106 with a game identification database 108, according to one embodiment.

In operation 910, the game identification server 100 may determine a game identifier 110 associated with the game identifying data 102. In operation 912, the game identification server 100 may associate the game identifier 110 with the public IP address 120 and/or the public IP address range of the television 104. In operation 914, the game identification server 100 may determine at least one client ID 124 associated with the public IP address 120 and/or the public IP address range using a device map table 126, according to one embodiment.

FIG. 9B is a continuation of the critical path view of FIG. 9A illustrating the critical operations of the game identification server 100 of FIG. 1A, according to at least one embodiment. In operation 916, the game identification server 100 may determine a particular client ID 128 received from a client device 130 associated with the game identifier 110. In operation 918, the television 104 may provide an advertising spot 132 to an advertising exchange 134. In operation 920, the advertising exchange 134 may provide an opportunity 137 to a real time bidder 136 to place a bid 138 for an advertisement 140. In operation 922, the advertising exchange 134 may provide a location identifier 142 of an advertisement of another game 144 to the client device 130 providing the advertising spot 132 upon successfully winning the bid 138. In operation 924, the advertising exchange 134 may place the advertisement 140 on an available advertising spot 146 when the client device 130 accesses an ad server 122 having the advertisement 140, according to one embodiment.

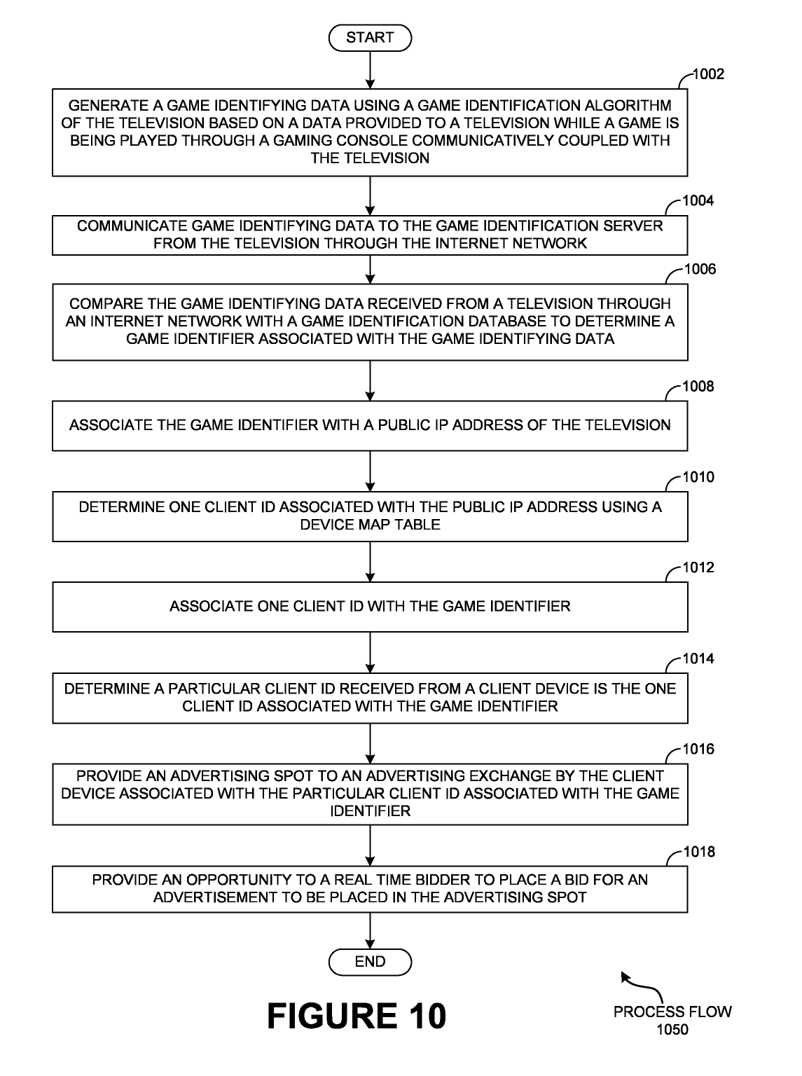

FIG. 10 is a process flow 1050 illustrating the generation of a game identifying data 102 using a game identification algorithm 112 of a television 104 based on a data 114 provided to the television 104 while a game 116 is being played through a game console 118 communicatively coupled with the television 104 of FIG. 1A, according to at least one embodiment. In operation 1002, a television 104 may generate a game identifying data 102 using a game identification algorithm 112 of the television 104 based on a data 114 provided to a television 104 while a game 116 is being played through a game console 118 communicatively coupled with the television 104. In operation 1004, a game console 118 may communicate game identifying data 102 to the game identification server 100 from the television 104 through an Internet network 106. In operation 1006, the game identification server 100 may compare the game identifying data 102 received from a television 104 through an Internet network 106 with a game identification database 108 to determine a game identifier 110 associated with the game identifying data 102, according to one embodiment.

In operation 1008, the game identification server 100 may associate the game identifier 110 with a public IP address 120 of the television 104. In operation 1010, the game identification server 100 may determine one client ID 124 associated with the public IP address 120 using a device map table 126. In operation 1012, the game identification server 100 may associate one client ID 124 with the game identifier 110. In operation 1014, the game identification server 100 may determine a particular client ID 128 received from a client device 130 is the one client ID 128 associated with the game identifier 110. In operation 1016, the client device 130 associated with the particular client ID 128 associated with the game identifier 110 may provide an advertising spot 132 to an advertising exchange 134. In operation 1018, the advertising exchange 134 may provide an opportunity 137 to a real time bidder 136 to place a bid 138 for an advertisement 140 to be placed in the advertising spot 132, according to one embodiment.

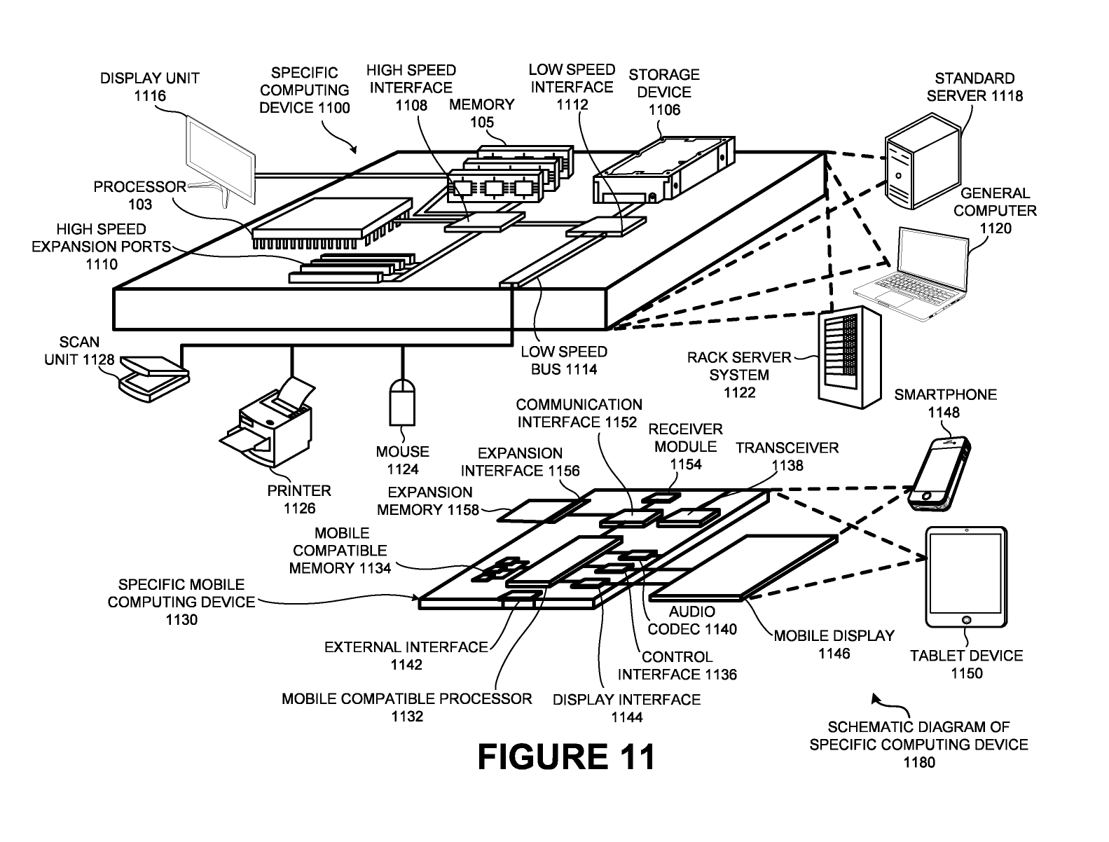

FIG. 11 is a schematic diagram of specific computing device 1180 that can be used to implement the methods and systems disclosed herein, according to one or more embodiments. FIG. 11 is a schematic diagram of specific computing device 1180 and a specific mobile computing device 1130 that can be used to perform and/or implement any of the embodiments disclosed herein. In one or more embodiments, game identification server 100 and/or client device 130 of FIG. 1A may be the specific computing device 1100, according to one embodiment.

The specific computing device 1100 may represent various forms of digital computers, such as laptops, desktops, workstations, personal digital assistants, servers, blade servers, mainframes, and/or other appropriate computers. The specific mobile computing device 1130 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed, according to one embodiment.

The specific computing device 1100 may include a processor 103, a memory 105, a storage device 1106, a high speed interface 1108 coupled to the memory 105 and a plurality of high speed expansion ports 1110, and a low speed interface 1112 coupled to a low speed bus 1114 and a storage device 1106. In one embodiment, each of the components heretofore may be inter-coupled using various buses, and may be mounted on a common motherboard and/or in other manners as appropriate. The processor 103 may process instructions for execution in the specific computing device 1100, including instructions stored in the memory 105 and/or on the storage device 1106 to display a graphical information for a GUI on an external input/output device, such as a display unit 1116 coupled to the high speed interface 1108, according to one embodiment.

In other embodiments, multiple processors and/or multiple buses may be used, as appropriate, along with multiple memories and/or types of memory. Also, a plurality of specific computing device 1100 may be coupled with, with each device providing portions of the necessary operations (e.g., as a server bank, a group of blade servers, and/or a multi-processor system).

The memory 105 may be coupled to the specific computing device 1100. In one embodiment, the memory 105 may be a volatile memory. In another embodiment, the memory 105 may be a non-volatile memory. The memory 105 may also be another form of computer-readable medium, such as a magnetic and/or an optical disk. The storage device 1106 may be capable of providing mass storage for the specific computing device 1100. In one embodiment, the storage device 1106 may be includes a floppy disk device, a hard disk device, an optical disk device, a tape device, a flash memory and/or other similar solid state memory device. In another embodiment, the storage device 1106 may be an array of the devices in a computer-readable medium previously mentioned heretofore, computer-readable medium, such as, and/or an array of devices, including devices in a storage area network and/or other configurations.

A computer program may be comprised of instructions that, when executed, perform one or more methods, such as those described above. The instructions may be stored in the memory 105, the storage device 1106, a memory coupled to the processor 103, and/or a propagated signal.

The high speed interface 1108 may manage bandwidth-intensive operations for the specific computing device 1100, while the low speed interface 1112 may manage lower bandwidth-intensive operations. Such allocation of functions is exemplary only. In one embodiment, the high speed interface 1108 may be coupled to the memory 105, the display unit 1116 (e.g., through a graphics processor and/or an accelerator), and to the plurality of high speed expansion ports 1110, which may accept various expansion cards.

In the embodiment, the low speed interface 1112 may be coupled to the storage device 1106 and the low speed bus 1114. The low speed bus 1114 may be comprised of a wired and/or wireless communication port (e.g., a Universal Serial Bus (“USB”), a Bluetooth® port, an Ethernet port, and/or a wireless Ethernet port). The low speed bus 1114 may also be coupled to the scan unit 1128, a printer 1126, a keyboard, a mouse 1124, and a networking device (e.g., a switch and/or a router) through a network adapter.

The specific computing device 1100 may be implemented in a number of different forms, as shown in the figure. In one embodiment, the specific computing device 1100 may be implemented as a standard server 1118 and/or a group of such servers. In another embodiment, the specific computing device 1100 may be implemented as part of a rack server system 1122. In yet another embodiment, the specific computing device 1100 may be implemented as a general computer 1120 such as a laptop or desktop computer. Alternatively, a component from the specific computing device 1100 may be combined with another component in a specific mobile computing device 1130. In one or more embodiments, an entire system may be made up of a plurality of specific computing device 1100 and/or a plurality of specific computing device 1100 coupled to a plurality of specific mobile computing device 1130.

In one embodiment, the specific mobile computing device 1130 may include a mobile compatible processor 1132, a mobile compatible memory 1134, and an input/output device such as a mobile display 1146, a communication interface 1152, and a transceiver 1138, among other components. The specific mobile computing device 1130 may also be provided with a storage device, such as a microdrive or other device, to provide additional storage. In one embodiment, the components indicated heretofore are inter-coupled using various buses, and several of the components may be mounted on a common motherboard.

The mobile compatible processor 1132 may execute instructions in the specific mobile computing device 1130, including instructions stored in the mobile compatible memory 1134. The mobile compatible processor 1132 may be implemented as a chipset of chips that include separate and multiple analog and digital processors. The mobile compatible processor 1132 may provide, for example, for coordination of the other components of the specific mobile computing device 1130, such as control of user interfaces, applications run by the specific mobile computing device 1130, and wireless communication by the specific mobile computing device 1130.

The mobile compatible processor 1132 may communicate with a user through the control interface 1136 and the display interface 1144 coupled to a mobile display 1146. In one embodiment, the mobile display 1146 may be a Thin-Film-Transistor Liquid Crystal Display (“TFT LCD”), an Organic Light Emitting Diode (“OLED”) display, and another appropriate display technology. The display interface 1144 may comprise appropriate circuitry for driving the mobile display 1146 to present graphical and other information to a user. The control interface 1136 may receive commands from a user and convert them for submission to the mobile compatible processor 1132.

In addition, an external interface 1142 may be provide in communication with the mobile compatible processor 1132, so as to enable near area communication of the specific mobile computing device 1130 with other devices. External interface 1142 may provide, for example, for wired communication in some embodiments, or for wireless communication in other embodiments, and multiple interfaces may also be used.

The mobile compatible memory 1134 may be coupled to the specific mobile computing device 1130. The mobile compatible memory 1134 may be implemented as a volatile memory and a non-volatile memory. The expansion memory 1158 may also be coupled to the specific mobile computing device 1130 through the expansion interface 1156, which may comprise, for example, a Single In Line Memory Module (“SIMM”) card interface. The expansion memory 1158 may provide extra storage space for the specific mobile computing device 1130, or may also store an application or other information for the specific mobile computing device 1130.

Specifically, the expansion memory 1158 may comprise instructions to carry out the processes described above. The expansion memory 1158 may also comprise secure information. For example, the expansion memory 1158 may be provided as a security module for the specific mobile computing device 1130, and may be programmed with instructions that permit secure use of the specific mobile computing device 1130. In addition, a secure application may be provided on the SIMM card, along with additional information, such as placing identifying information on the SIMM card in a non-hackable manner.

The mobile compatible memory may include a volatile memory (e.g., a flash memory) and a non-volatile memory (e.g., a non-volatile random-access memory (“NVRAM”)). In one embodiment, a computer program comprises a set of instructions that, when executed, perform one or more methods. The set of instructions may be stored on the mobile compatible memory 1134, the expansion memory 1158, a memory coupled to the mobile compatible processor 1132, and a propagated signal that may be received, for example, over the transceiver 1138 and/or the external interface 1142.

The specific mobile computing device 1130 may communicate wirelessly through the communication interface 1152, which may be comprised of a digital signal processing circuitry. The communication interface 1152 may provide for communications using various modes and/or protocols, such as, a Global System for Mobile Communications (“GSM”) protocol, a Short Message Service (“SMS”) protocol, an Enhanced Messaging System (“EMS”) protocol, a Multimedia Messaging Service (“MMS”) protocol, a Code Division Multiple Access (“CDMA”) protocol, Time Division Multiple Access (“TDMA”) protocol, a Personal Digital Cellular (“PDC”) protocol, a Wideband Code Division Multiple Access (“WCDMA”) protocol, a CDMA2000 protocol, and a General Packet Radio Service (“GPRS”) protocol.

Such communication may occur, for example, through the transceiver 1138 (e.g., radio-frequency transceiver). In addition, short-range communication may occur, such as using a Bluetooth®, Wi-Fi, and/or other such transceiver. In addition, a GPS (“Global Positioning System”) receiver module 1154 may provide additional navigation-related and location-related wireless data to the specific mobile computing device 1130, which may be used as appropriate by a software application running on the specific mobile computing device 1130.

The specific mobile computing device 1130 may also communicate audibly using an audio codec 1140, which may receive spoken information from a user and convert it to usable digital information. The audio codec 1140 may likewise generate audible sound for a user, such as through a speaker (e.g., in a handset smartphone of the specific mobile computing device 1130). Such a sound may comprise a sound from a voice telephone call, a recorded sound (e.g., a voice message, a music files, etc.) and may also include a sound generated by an application operating on the specific mobile computing device 1130.

The specific mobile computing device 1130 may be implemented in a number of different forms, as shown in the figure. In one embodiment, the specific mobile computing device 1130 may be implemented as a smartphone 1148. In another embodiment, the specific mobile computing device 1130 may be implemented as a personal digital assistant (“PDA”). In yet another embodiment, the specific mobile computing device, 1130 may be implemented as a tablet device 1150.

An example embodiment will now be described. The ACME Gaming Inc. may be actively working in development and publishing video games for several acclaimed video game franchises. The ACME Gaming Inc. may have been spending a substantial portion of its budget in advertising for new games through online and offline brand advertising prior to and shortly after a game release because newer games may sell better than older ones. Despite huge spending on advertisements, the ACME Gaming Inc. may have failed to get clear estimation of a game's potential demand prior to launch. Furthermore, ACME Gaming Inc. may spend advertising dollars inefficiently, resulting in losses.

To prevent its invaluable losses, the ACME Gaming Inc. may have decided to invest in embodiments described herein (e.g., use of various embodiments of the FIGS. 1-11) to get a clear estimation of a game's potential demand before its release. The use of technologies described in various embodiments of the FIGS. 1-11 may enable the ACME Gaming Inc. to target potential customer audiences for a particular video game before release, thereby optimizing its resources. The use of technologies described in various embodiments of the FIGS. 1-11 may have helped the ACME Gaming Inc. to allocate advertising spend effectively by targeting gamers who had purchased similar games and/or complementary games.

It will be understood to those with skill in the art that television is just one example of a network media device, as described herein. For example, a Denmark Games may have recently finished creating a first person shooter games Foo Killers 3 for the Wowbot Game Console. Joe Smith may regularly play first person shooters on his Wowbot Game Console. As the release date approaches, Joe may increasingly see advertisements for Foo Killers 3 while surfing the web, using mobile apps, and watching television thanks to the various embodiments described in FIGS. 1-11.

Joe's neighbor Kyle Jones may never play first person shooters but may also own a Wowbot Game Console. Joe's other neighbor Mary Henderson may play first person shooters, but she may only own a NationPlay Game Console. Craig Wilson down the street may own a Wowbot Game Console and may play first person shooters, but he may have played only the first level of Foo Killers 2, the previous game in the series to the new release, before he stopped playing the game altogether. Mary, Kyle, Craig may not see any advertisements for Foo Killers 3 based on the various advertisement targeting parameters described in FIGS. 1-11.

It should be understood that in one embodiment of FIGS. 1-11, the above may be achieved via a combination of building blocks including:

(1) a piece of software may be in the user's TV identifies games, progress through games, and/or make and/or model of the user's game console(s),

(2) a method may associates the game console and/or the user's TV connected to the game console with other devices used by the game player such as his or her laptop or phone, and

(3) a method for buying ad space and delivering ads that may appear on the user's other devices.

The software that identifies games, progress through games, and the make or model of a user's game console may make these determinations based on metadata embedded within the signals from the game console to the TV. For example, the make and model of the game console may be transmitted to the TV through an HDMI cable using HDMI-CEC. When there is no or inadequate metadata, the software may identify games, progress through games, and/or the make or model of a user's game console based on properties extracted from the audio and/or video passing from the game console through the TV.

For example, games may have unique video sequences that may appear at points in the game. Identifying any of these video sequences thus may not only identify the game, but also may often identify progress through the game. One can imagine that a user that progresses further in a game may be more impressed with the game and/or is a more avid fan of the game's genre. Utilizing this information may enable game advertisers to more wisely spend their advertising budget to reach those users most likely to purchase a similar game.

A technique for identifying video may be Automatic Content Recognition (ACR) in accordance with the various embodiments described herein in FIGS. 1-11. Video-based ACR algorithms may generate fingerprints based on properties of the video and send the fingerprints to a server. These fingerprints may be analogous to the fingerprints one leaves behind when one touches a glass. The fingerprint may be a trace that is often sufficiently unique to identify a single individual when compared against fingerprints obtained from the same individual. With a properly constructed database, a single fingerprint may be compared against thousands or millions to find a matching fingerprint thus identifying the individual. Similarly a video fingerprint may be a tiny representation of a video that can be transmitted and/or compared against previously and/or concurrently generated fingerprints arriving from trusted sources like cable or TV stations. Should sufficiently matching fingerprints be found, the video may thus be identified.

Video-based ACR may represent only one embodiment by which a game and/or progress through a game might be determined in accordance with FIGS. 1-11. Another embodiment may use audio-based ACR that identifies a game or progress through a game based on the music or sounds within the game. Another embodiment may use Optical Character Recognition (OCR) to identify names appearing within the game including potentially the game's title sequence. Another embodiment may use Logo Detection to identify game or level-specific logos.

As with identifying games and progress through games, identifying the game console may represent an important piece of information when targeting ads at users. For example, there may be little point in serving ads to users that do not own a compatible game console. ACR may represent an embodiment used in identifying game consoles, since a game console may display a short video sequence called a “splash screen” that appears when the game console is booted. This “splash screen” may uniquely identify the make, model, and/or brand of the game console. Another embodiment may use logo detection to identify a game console specific logo.

Once ads have been shown to potential customers, game companies may wish to know the effectiveness of their ads. The same techniques that identify previously played games as inputs to ad targeting can be used to identify whether a user plays a game when that user had been previously been exposed to an ad campaign. When a user plays a game and the various embodiments identify the play, such an event may be described as a “verified play.” Various metrics of ad effectiveness may be derived from verified plays. For example, the “Verified Play Rate” (VPR) for game X may be the fraction of known users that have at least one verified played of game X. Advertisers may measure ad effectiveness as the VPR amongst those that were exposed to an ad campaign such as Joe versus those that were not such as Mary, Kyle, and Craig. Verified Play Rate of those exposed to an ad may be an example attribution metric accordance with FIGS. 1-11.

“A method that associates the game console or the user's TV connected to the game console with other devices used by the game player such as his or her laptop or phone” may refer to “communicative coupling.” This information might be collected and used to enable buying and delivering ads to client devices. Types of communicative coupling between client device and the network media device in accordance with the embodiments of FIGS. 1-11 may include:
sharing public IP address.
sharing IP address range. This may represent a looser inference since the two devices may be less likely to belong to the same user when they have different public IP addresses.
sharing public IP and/or IP address range plus network media device can see client device on the network. Discovery system in network media device may be less constrained than in the client device and thus may be able to look at Address Resolution Protocol (ARP) caches and/or routing tables to see what devices are on the network.
sharing public IP and/or IP address range plus javascript running in client device can use cross-site scripting (e.g., CORS, sandbox-reachable services) to open a connection to a web server on the TV. If the client device and/or network media device are on the same network then the connection succeeds.
client device or network media device may use broadcast or multicast based discovery (e.g., SSDP used by uPnP, mDNS/DNS-SD used by Bonjour and Airplay) to discover a network media device that is running a Game ID service. The Game ID service may be ACR-based.
client device and network media device may not be on the same network but they might both see the same WiFi base station even if one or both cannot connect to the base station. Alternatively both can see the same antenna of any kind even if one or both cannot connect to or otherwise communicate via the antenna other to recognize the antenna's existence.
client device and network media device may have nearby geolocations even if they are not on the same communications network. Each device may directly or indirectly determine its geolocation. An example of direct determination may be GPS. An example of indirect determination may include either device learning its geolocation from a prior coupling with a device that offered its geolocation provided either device has a reason to believe the geolocation is still valid. For example, a TV does not move often and if it learned its location from another device it may be likely the geolocation is still valid.
Analogous definitions of “communicative coupling” can occur between the client device and the game console if the game console is the entity identifying games for purposes of targeting ads. “Communicatively coupled” may mean that direct communication must take place between the “communicatively coupled” devices. For example, the fact that two devices share the same public IP can be enough to say that they are “communicatively coupled.”

The third major component: “a method for buying and delivering ads that appear on the user's other devices” will now be described. To obtain scale, a provider (e.g., Samba TV) may buy ad spots from ad exchanges and/or offer data to parties that buy ads spots on ad exchanges. Samba TV's servers may communicate with the TVs running ACR and thus may know the public IP of these TVs as well as what games, how often, and how long are played on these TVs, and what game console(s) are connected to each TV. It will hereafter refer to the games played, how often, and how long and which game consoles as examples of “game data.”

The trick may be to get from TV ID to ad exchange user IDs. Ad exchange user IDs may include but may not be limited to Double Click User IDs (a.k.a., google_gid), Apple's ID For Advertisers (IDFAs), Facebook User IDs, and AppNexus User IDs. Ad exchanges may understand “ad exchange user IDs.” In the case of Google's Ad Exchange, ad buyers may submit to Google a “match table” which includes a list of all the google_gids that interest the ad buyer. Google may then forward a bid request to the ad buyer's Real Time Bidder (RTB) each time one of the users with an associated google_gid visits a web site with an ad spot that is submitted to the Google Ad Exchange. Google may not reveal the user's public IP. It may be up to each bidder to correlate each user's google_gid to any data that might influence bidding. In the case of the various embodiments of FIGS. 1-11, a correlation our game players to google_gids and use our game player's game data to determine when and how much to bid on the Google Ad Exchange.

The various embodiments of FIGS. 1-11 build several mappings:
TV ID-->targetable game data
TV ID-->public IP address
public IP address-->ad exchange user IDs (e.g., google_gid) obtained from other devices behind the public IP address

The various embodiments of FIGS. 1-11 may build the last mapping from various sources including 1) on-ramping companies (e.g., Krux) that have already built a mapping between public IP addresses and ad exchange user IDs, and 2) from tiny 1×1 invisible pixels (IMG tags) the various embodiments may have on various web sites. For example, the various embodiments may have an IMG tag on A&E's web site which links back to a Samba TV web server. When a user visits A&E, the user's browser may try to load all images on the page including Samba TV's 1×1 pixel from the Samba TV server. Samba TV may log each such request. The various embodiments of FIGS. 1-11 may use logged requests for this pixel to correlate visitors to A&E's web site with viewers of A&E TV Programs. This IMG tag may serve a second purpose in that may allow the system to see the public IPs of the users visiting A&E's web site and may allow the system to cookie sync with Double Click for each of these users.

Once the various embodiments of FIGS. 1-11 have all of the above mappings, it may be easy to correlate targetable game data to google_gids (e.g., the game developer Bungie that wanted to target people likely to buy the game Destiny), The various embodiments of FIGS. 1-11 may look through targetable game data to find all the known google_gids associated with people from behind the same public IP as a TV connected to a game console on which similar games were played. The various embodiments of FIGS. 1-11 may then submit this list of google_gids as a match table to Double Click. Double Click may then forward to our Real time Bidder bid requests for ad spots from web pages visited by anyone with one of the google_gids listed in the match table.

The match table the various embodiments of FIGS. 1-11 may submit to Google may include google_gids across all the users with TVs for which Samba has targetable data. Only our Real Time Bidder may have access to the targetable data and thus may know why bids were placed. The various embodiments of FIGS. 1-11 may never have to reveal to Google which games were played by which players.

The various embodiments of FIGS. 1-11 may enable selling of “data segments” containing lists of users that meet certain criteria such as those who play “first person shooters,” The data segments may simply be lists of google_gids. On AppNexus, the various embodiments of FIGS. 1-11 may be integrated as a “data provider.” The various embodiments of FIGS. 1-11 may see a large fraction of AppNexus ad spots. When the various embodiments of FIGS. 1-11 see a hid request for a user for which the various embodiments have matching game targeting data, the various embodiments may append to the bid request one or more associated “segment IDs” The bid request may then passed on to various real time bidders that may bid based on the segment ID. In these cases, SambaTV may not participate in the bid and thus may be unable to exploit the arbitrage, hut the various embodiments may charge ad buyers for use of segment IDs. The method associates the game identifier with the TV ID.

In one embodiment, the method may associate the TV with a TV ID. The method may maintain a mapping between TV ID and its public IP. The method may maintain a description of the household network as reported by the TV such as the household network's IP address range. Client devices may be associated with the TV by virtue of them residing behind the same public IP or within the same IP address range as the TV.

The public IP may change but the TV ID remains the same. The association between client devices in the household and public IPs may change, but the association between the TV and client devices in the household may change much less frequently. When a client device communicates with the Game Identification Server via a pixel dropped alongside an ad and/or via an attribution pixel on a web site, the Game Identification Server may look up the TV or TVs with the same IP and then may associate the client device with the TV ID. Thus in some embodiments, the Device Map Table may contain a mapping from TV ID to Client ID(s) and vice versa. Such embodiments may be robust to changes in the public IP of the TV because whenever the TV is turned back on, it may communicate with the Game Identifying Server causing the TV-to-IP map to be updated and thus any further appearances of client devices from behind the new public IP of the TV may still associated with the appropriate TV. In addition, the client device might be associated with the TV by other means than public IP. For example, the client device and TV might be associated by any of the means described in the description above.

In addition, the ad exchange may know how to forward an opportunity to the real time bidder (RTB). One way this may operate is:

(1) The real time bidder may provide the client ID (or a list of client IDs) for which the RTB is interested. The list of client IDs may be called a “hosted match table.” It may be “hosted” because DoubleClick may retain a copy of the table into which it looks up before forwarding opportunities (i.e., bid requests) to ad exchanges.

(2) When a web page or application submits an ad spot to the exchange, it may include a cookie that includes the client ID.

(3) The ad exchange may forward the opportunity (bid request) to the real time bidders that have registered an interest in the client ID.

The technologies described in various embodiments of the FIGS. 1-11 may allow the ACME Gaming Inc. to get a real time visualization and analytics to measure future demand for its new products (e.g., another game 212). The automatic content recognition (using automatic content recognition algorithm 518 of game identification server 100), as described in various embodiments of the FIGS. 1-11, may have empowered the ACME Gaming Inc. to vastly increase the return on investment in advertising spend for new game releases.

The implementation of various techniques as described in various embodiments of the FIGS. 1-11, may have enabled the ACME Gaming Inc. to spend its advertising budget efficiently reducing its losses. Additionally, the use of various embodiments of the FIGS. 1-11 may have helped the ACME Gaming Inc. in getting a clear estimation of its game's potential demand from its future customer audiences making its products successful when launched resulting ultimately in profits.

Various embodiments of the systems and techniques described here can be realized in a digital electronic circuitry, an integrated circuitry, a specially designed application specific integrated circuits (“ASICs”), a piece of computer hardware, a firmware, a software application, and a combination thereof. These various embodiments can include embodiment in one or more computer programs that are executable and/or interpretable on a programmable system including one programmable processor, which may be special or general purpose, coupled to receive data and instructions from, and to transmit data and instructions to, a storage system, one input device, and at least one output device.

These computer programs (also known as programs, software, software applications, and/or code) comprise machine-readable instructions for a programmable processor, and can be implemented in a high-level procedural and/or object-oriented programming language, and/or in assembly/machine language. As used herein, the terms “machine-readable medium” and/or “computer-readable medium” refers to any computer program product, apparatus and/or device (e.g., magnetic discs, optical disks, memory, and/or Programmable Logic Devices (“PLDs”)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computing device having a display device (e.g., a cathode ray tube (“CRT”) and/or liquid crystal (“LCD”) monitor) for displaying information to the user and a keyboard and a mouse 1124 by which the user can provide input to the computer. Other kinds of devices can be used to provide for interaction with a user as well; for example, feedback provided to the user can be any form of sensory feedback (e.g., visual feedback, auditory feedback, and/or tactile feedback) and input from the user can be received in any form, including acoustic, speech, and/or tactile input.

The systems and techniques described here may be implemented in a computing system that includes a back end component (e.g., as a data server), a middleware component (e.g., an application server), a front end component (e.g., a client computer having a graphical user interface, and/or a Web browser through which a user can interact with an embodiment of the systems and techniques described here), and a combination thereof. The components of the system may also be coupled through a communication network.

The communication network may include a local area network (“LAN”) and a wide area network (“WAN”) (e.g., the Internet). The computing system can include a client and a server. In one embodiment, the client and the server are remote from each other and interact through the communication network.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method of a game identification server, comprising:
comparing a game identifying data received from a television through an Internet network with a game identification database to determine a game identifier associated with the game identifying data,
wherein the game identifying data is generated using a game identification algorithm of the television based on a data provided to the television while a game is being played through a game console communicatively coupled with the television, and
wherein the game identifying data is communicated to the game identification server from the television through the Internet network; and
associating the game identifier with the television associated with at least one of a public IP address and an IP address range,
wherein at least one client ID associated with at least one of the public IP address and the IP address range using a device map table is determined,
wherein the at least one client ID with the game identifier is associated,
wherein a particular client ID received from a client device is the at least one client ID associated with the game identifier is determined,
wherein the client device associated with the particular client ID associated with the game identifier provides an advertising spot to an advertising exchange,
wherein the advertising exchange provides an opportunity to a real time bidder to place a bid for an advertisement to be placed in the advertising spot,
wherein a location identifier of an advertisement of another game to the game associated with the game identifier is provided to the client device providing the advertising spot upon successfully winning the bid from the advertising exchange, and
wherein the advertisement is placed on an available advertising spot on the client device when the client device accesses an ad server having the advertisement through the location identifier.

2. The method of the game identification server of claim 1, comprising:
determining that the advertisement is displayed on the client device based on a request embedded in the advertisement on the client device that communicates at least one of a public IP address, an IP address range, a client id, and an ad id, to an attribution analyzer;
determining that at least one of the public IP address and the client ID is associated with the client device;
placing an association of the advertisement with the client device in an attribution table;
comparing an another game identifying data received from the television through the Internet network with the game identification database to determine that another game identifier associated with the another game identifying data is that of an another game; and
determining that the advertisement likely caused at least one of a play and a purchase of the another game when it is determined that the client device displayed the advertisement based on the association of the advertisement with the client device in the attribution table and the another game identifier associated with the another game identifying data is that of the another game.

3. The method of claim 2:
wherein the public IP address is automatically visible to the game identification server,
wherein the data is at least one of an audio, a video, and a metadata generated by at least one of the game and the game console; and
wherein the location identifier is a Uniform Resource Locator (URL) code.

4. The method of claim 2:
wherein the request to place a cookie on the client device is performed such that the cookie to include the client ID of the client device, and communicate the client ID to one of the attribution analyzer, the advertising exchange, and the real time bidder.

5. The method of claim 4:
wherein the request is a pixel having an embedded image Uniform Resource Locator (URL) that refers to the attribution analyzer.

6. The method of claim 1:
wherein a user identifying data is generated using a user identification algorithm of the television based on the data provided to the television while the game is being played through the game console communicatively coupled with the television, wherein the data is at least one of a video data, an audio data, and a metadata.
wherein a behavioral data is generated using a behavior identification algorithm of the television for each user identified using the user identification algorithm based on the data provided to the television while the game is being played through the game console communicatively coupled with the television, and
wherein examples of the behavioral data includes at least one of a length of game play, a stopping location of the game, a level of the game, how often the game is played, and how long the game is played.

7. The method of claim 1, wherein a game identifying data is at least one of a name, a game title, an audio fingerprint, a video fingerprint, a game logo detection, an optical character recognition of the game title, a splash screen, an automatic content recognition data, and a metadata provided from the game console to the television.

8. The method of claim 1:
wherein the game identifier is at least one of a game name, a stock keeping unit, a game genre, an age group, a game version, and a game language, and
wherein the ad server to store creative artwork associated with potential advertisements.

9. The method of claim 1:
wherein the client ID is any one of a DoubleClick® ID, a Google® GID, an Apple® IDFA, an AppNexus® ID, and
wherein the client ID to maintain a static identifier across different physical locations of the client device.

10. The method of claim 1:
wherein the client device is at least one of a mobile phone, a tablet, a desktop computer, an Internet enabled appliance, a wearable computer, an Internet enabled watch, an Internet enabled glasses, a projected computing environment, and the television itself, and
wherein the another game is at least one of a newly released game, a similar game, a complementary game, and a related game.

11. The method of claim 1:
wherein the advertising spot is at least one of a display advertisement spot, a text advertisement spot, a video advertisement spot, an audio advertisement spot, a banner advertisement spot, and a textual advertisement spot, and
wherein the advertisement spot includes metadata about at least one of a name of an application and a website in which the advertisement appears, a location of the advertisement spot, a size of the advertisement spot, and a type of the advertisement spot.

12. The method of claim 1 further comprising:
determining that the game is accessed through a game console;
analyzing a session of play by a user of the game;
determining a timing and a location of a game event rendered during the session of play by the user of the game in the game accessed through the game console, wherein the game event is at least one of an appearance of a game object, reaching a level, an amount of time played, and a number of times played;
applying an automatic event recognition algorithm to the game event to determine that the game event is associated with at least one of a product and a service for sale;
associating a time stamp with the session of play and the timing and the location of the game event;
determining the client device is associated with the user that accesses the game through the game console;
selecting an advertisement formatted for a display area of the client device that is associated with the game event based on a contextual match between the game event and the advertisement; and
delivering the advertisement to the client device within a predetermined time threshold of the time stamp associated with the session of play and the timing and the location of the game event.

13. The method of claim 12, wherein the advertisement is at least one of an alphanumeric advertisement, a textual advertisement a display advertisement, and an audio-visual advertisement.

14. The method of claim 13 further comprising:
determining that the user has interacted with the advertisement when the user selects a hyperlink in the advertisement; and
periodically displaying the game event on the game console based on a determination that the user has interacted with the advertisement by selecting the hyperlink in the advertisement.

15. The method of claim 14 further comprising:
automatically inferring at least one of a current association and a previous association of the client device with at least one of the television and the game console;
automatically identifying a first advertisement that is at least one of displayed on the television by the game console and broadcast directly to the television;
automatically associating the time stamp with the first advertisement; and
automatically targeting a second advertisement to the client device based on the first advertisement and within the predetermined time threshold of the time stamp.

16. The method of claim 15,
determining that the user has interacted with the second advertisement when the user selects the hyperlink in the second advertisement;
periodically displaying the first advertisement on the game console based on the determination that the user has interacted with the second advertisement by selecting the hyperlink in the second advertisement; and
automatically cataloguing the first advertisement,
wherein the first advertisement is a virtual object.

17. The method of claim 12, wherein the automatically identifying is through a tag associated with a first advertisement.

18. The method of claim 12, wherein a second advertisement is automatically targeted to the client device during at least one of an inferred interaction of the user with the client device and an inferred cessation of interaction of the user with the game console.

19. The method of claim 12, wherein at least one of the inferring and the automatically targeting is through at least one of a web browser and an application of the client device.

20. The method of claim 12, wherein a second advertisement is interactive.

21. The method of claim 12, wherein the at least one of the current association and the previous association of the client device with at least one of the television and the game console is inferred based on at least one of an IP address range, the public IP address, a base station MAC address, a base station BSSID, a base station SSID, a Bluetooth® MAC address, a geolocation, a WiFi direct MAC address of the game console, a WiFi direct BSSID of the game console, a short code, a username, and a quick response (QR) code that is at least one of shared by and visible to both the client device and at least one of the television and the game console.

22. The method of claim 12, wherein the at least one of the current association and the previous association of the client device with at least one of the television and the game console is inferred based on a mutually visible identifying signal from at least one of the game console and a device external to the game console, independent of whether at least one of the game console and the client device can connect to a third device other than to receive the identifying signal.

23. The method of claim 12, wherein the at least one of the current association and the previous association of the client device with at least one of the television and the game console is inferred based on whether redirecting at least one of a browser of the client device and an application of the client device to a private IP address of the game console establishes a communication between the client device and at least one of the television and the game console.

24. The method of claim 12, wherein the at least one of the current association and the previous association of the client device with at least one of the television and the game console is inferred based on whether instructing an application of the client device to perform at least one of a multicast and a broadcast based discovery establishes a communication between the client device and at least one of the television and the game console.

25. The method of claim 12, wherein the automatically identifying is through an automatic content recognition (ACR) of at least one of the television and the game console.

26. A method of a game identification server, comprising:
comparing a game identifying data received from a television through an Internet network with a game identification database to determine a game identifier associated with the game identifying data,
wherein the game identifying data is generated using a game identification algorithm of the television based on a data provided to the television while a game is being played through a game console communicatively coupled with the television, and
wherein the game identifying data is communicated to the game identification server from the television through the Internet network;
associating the game identifier with at least one of a public IP address, an IP address range, and a unique identifier of the television; and
determining that an advertisement is displayed on a client device based on a request embedded in the advertisement on the client device that communicates at least one of the public IP address, the IP address range, the unique identifier, a client id, and an ad id, to an attribution analyzer,
wherein at least one client ID associated with at least one of the public IP address, the IP address range, and the unique identifier using a device map table is determined,
wherein the at least one client ID with the game identifier is associated,
wherein a particular client ID received from the client device is the at least one client ID associated with the game identifier is determined,
wherein the client device associated with the particular client ID associated with the game identifier provides an advertising spot to an advertising exchange,
wherein the advertising exchange provides an opportunity to a real-time bidder to place a bid for the advertisement to be placed in the advertising spot,
wherein a location identifier of an advertisement of another game to the game associated with the game identifier is provided to the client device providing the advertising spot upon successfully winning the bid from the advertising exchange, and
wherein the advertisement is placed on an available advertising spot on the client device when the client device accesses an ad server having the advertisement through the location identifier.

27. The method of the game identification server of claim 26, comprising:
determining that at least one of the public IP address and a client ID is associated with the client device;
placing an association of the advertisement with the client device in an attribution table;
comparing an another game identifying data received from the television through the Internet network with the game identification database to determine that another game identifier associated with the another game identifying data is that of an another game; and
determining that the advertisement likely caused a purchase of the another game when it is determined that the client device displayed the advertisement based on the association of the advertisement with the client device in the attribution table and the another game identifier associated with the another game identifying data is that of the another game.

28. The method of claim 27:
wherein the request to place a cookie on the client device such that the cookie to include the client ID of the client device, and communicate the client ID to the attribution analyzer.

29. A system, comprising:
a game identification server:
to compare a game identifying data received from a television through an Internet network with a game identification database to determine a game identifier associated with the game identifying data,
wherein the game identifying data is generated using a game identification algorithm of the television based on a data provided to the television while a game is being played through a game console communicatively coupled with the television, and
wherein the game identifying data is communicated to the game identification server from the television through the Internet network; and
to associate the game identifier with at least one of a public IP address and an IP address range of the television,
wherein at least one client ID associated with at least one of the public IP address and the IP address range using a device map table is determined, and
wherein the at least one client ID with the game identifier is associated.
an Internet;
a client device to provide a particular client ID
wherein the particular client ID received from the client device is the at least one client ID associated with the game identifier is determined,
wherein the client device associated with the particular client ID associated with the game identifier provides an advertising spot to an advertising exchange,
wherein the advertising exchange provides an opportunity to a real time bidder to place a bid for an advertisement to be placed in the advertising spot,
wherein a location identifier of an advertisement of another game to the game associated with the game identifier is provided to the client device providing the advertising spot upon successfully winning the bid from the advertising exchange, and
wherein the advertisement is placed on an available advertising spot on the client device when the client device accesses an ad server having the advertisement through the location identifier.

30. The system of claim 29, wherein the game identification server:
to determine that the advertisement is displayed on the client device based on a request embedded in the advertisement on the client device that communicates at least one of a public IP address, client id, and an ad id, to an attribution analyzer;
to determine that at least one of the public IP address and a client ID is associated with the client device;
to place an association of the advertisement with the client device in an attribution table;
to compare an another game identifying data received from the television through the Internet network with the game identification database to determine that another game identifier associated with the another game identifying data is that of an another game; and
to determine that the advertisement likely caused at least one of a play and a purchase of the another game when it is determined that the client device displayed the advertisement based on the association of the advertisement with the client device in the attribution table and the another game identifier associated with the another game identifying data is that of the another game.
